(19) United States
(12) Patent Application Publication
(10) Pub. No.: US 2017/0207866 A1
(43) Pub. Date: Jul. 20, 2017

(54) WIRELESS COMMUNICATION DEVICE, WIRELESS COMMUNICATION SYSTEM, AND INTERFERENCE DETERMINATION METHOD

(71) Applicant: FUJITSU LIMITED, Kawasaki-shi (JP)

(72) Inventor: Hiroshi Fujita, Yokosuka (JP)

(73) Assignee: FUJITSU LIMITED, Kawasaki-shi (JP)

(21) Appl. No.: 15/383,094

(22) Filed: Dec. 19, 2016

(30) Foreign Application Priority Data
Jan. 18, 2016 (JP) 2016-007408

(51) Int. Cl. H04B 17/345; H04W 24/08

(52) U.S. Cl. CPC H04B 17/345; H04W 24/08

(57) ABSTRACT

An AP includes a transmission unit, a receiving unit, a packet length calculating unit, a response time calculating unit, and a determination unit. The transmission unit transmits a data packet to a terminal device in accordance with a transmission instruction. The receiving unit receives, from the terminal device, an ACK packet with respect to the data packet transmitted to the terminal device. The packet length calculating unit calculates a packet length that is a temporal length of the data packet transmitted to the terminal device. The response time calculating unit calculates second response time by subtracting the packet length calculated by the packet length calculating unit from first response time that is the amount of time from the transmission instruction to reception of the ACK packet. The determination unit determines, on the basis of the second response time, whether the terminal device is subjected to interference.

### CROSS-REFERENCE TO RELATED APPLICATION

This application is based upon and claims the benefit of priority of the prior Japanese Patent Application No. 2016-007408, filed on Jan. 18, 2016, the entire contents of which are incorporated herein by reference.

### FIELD

The embodiment discussed herein is related to a wireless communication device, a wireless communication system, and an interference determination method.

### BACKGROUND

Because wireless networks, such as wireless local area networks (LANs), or the like, that use radio waves of the industry science medical (ISM) bands, can be easily used without a need of a license, use scenes of the wireless networks are increased. However, if wireless communication devices that use radio waves in the ISM bands are used without a plan, both the devices give radio-frequency interference with each other and a communication environment becomes unstable. Thus, in order to stably use communication networks, operational maintenance is important. If a large-scale network is used, monitoring of the networks and failure measures are performed by a professional operational maintenance company or an information system department. Furthermore, because no operational maintenance department is present in a personal residence or in a small-scale network, users need to cope with a failure by themselves.

However, because the radio waves are invisible, it is not easy to specify the cause of a failure in a wireless network. Furthermore, if a failure intermittently occurs, it is difficult to discern an occurrence point of the failure. In this way, because it is difficult to specify the cause of a failure in a wireless network, it is difficult to appropriately handle the failure. Even for a specialist in operational maintenance, in many cases, symptomatic treatment handling is performed by using know-how accumulated from experiences; therefore, if fundamental measures are not taken, the failure may possibly recur. Furthermore, with a spread and an increase of the wireless network, the number of operational maintenance companies may possibly be insufficient. Consequently, an operational maintenance technology that improves the stability of networks and that reduces the workload is needed.

For example, there is a known technology in which a device in a wireless LAN sends an inspection packet and receives an acknowledgement (ACK) packet for several times and detects an interference state on the basis of variation in response time that is the amount of time from the transmission of the inspection packet to the reception of the ACK packet. Prior art example is disclosed in Japanese Laid-open Patent Publication No. 2008-205651.

However, if an inspection packet is transmitted during operation, there may be a case in which traffic is uselessly consumed due to the inspection packet and throughput of user data is decreased. Thus, it is conceivable to measure, by using data packet including user data, variation in response time that is the amount of time from the transmission of the data packet to the reception of the ACK packet.

Here, the device that performs communication in a wireless LAN may sometimes appropriately change a communication mode, such as a modulation mode, or the like, due to a radio wave environment or the like. If the communication mode is changed, even in a case of a data packet that has the same amount of data, the packet length that is the temporal length of the data packet may sometimes be changed. For example, if a data packet having the same amount of data is transmitted, in a communication mode in which the transmission rate is high, the packet length of the data packet becomes short and, in a communication mode in which the transmission rate is low, the packet length becomes of the data packet becomes long. Thus, even if the response time that is the amount of time from the transmission of the data packet to the reception of the ACK packet becomes long due to a change in the communication mode, the response time may possibly be erroneously determined to be long due to interference.

Furthermore, among the functions of the wireless LAN, there is a function called a block ACK that transmits a plurality of data packets at a time and that returns a response once with respect to the plurality of data packets that are transmitted at a time. If a block ACK is used, the device on the reception side does not return a response until the reception of the data packets that are transmitted at a time has been completed. Thus, if the block ACK is used, the time from the start of the transmission of the data packets to the completion of the reception of the response may possibly be longer than a case of the communication mode in which pieces of data are transmitted per packet. Thus, even if the length of the response time becomes long due to the of the plurality of data packets being collectively transmitted at a time, the response time may possibly be erroneously determined to be long due to interference. Accordingly, it is difficult to accurately detect the interference state by using only the response time from the transmission of the data packets to the reception of the ACK packet.

### SUMMARY

According to an aspect of an embodiment, a wireless communication device that is used in a wireless communication system that includes the wireless communication device and a plurality of terminal devices, the wireless communication device includes a transmission unit, a receiving unit, a first calculating unit, second calculating unit, and a determination unit. The transmission unit transmits a data packet to the terminal device in accordance with a transmission instruction. The receiving unit receives, from the terminal device, a response with respect to the data packet transmitted to the terminal device. The first calculating unit calculates a packet length that is a temporal length of the data packet transmitted to the terminal device. The second calculating unit calculates second response time by subtracting the packet length from first response time that is amount of time from the transmission instruction to reception of the response. The determination unit determines, based on the second response time, whether the terminal device is subjected to interference.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a wireless communication system;

FIGS. 2A to 2C are schematic diagrams illustrating an example of first response time;

FIGS. 3A and 3B are schematic diagrams illustrating an example of the first response time;

FIG. 4 is a block diagram illustrating an example of an AP;

FIG. 5 is a schematic diagram illustrating an example of a measurement value table;

FIG. 6 is a schematic diagram illustrating an example of a response time table;

FIG. 7 is a schematic diagram illustrating an example of a packet loss rate table;

FIG. 8 is a schematic diagram illustrating an example of a received signal strength indicator (RSSI) table;

FIG. 9 is a schematic diagram illustrating an example of a log table;

FIG. 10 is a schematic diagram illustrating an example of a terminal list table;

FIG. 11 is a flowchart illustrating an example of a reference value creating process;

FIG. 12 is a flowchart illustrating an example of a start time specifying process;

FIG. 13 is a flowchart illustrating an example of a packet length calculation process;

FIG. 14 is a flowchart illustrating an example of a measurement process;

FIG. 15 is a flowchart illustrating an example of a failure determination process;

FIG. 16 is a flowchart illustrating an example of a shielding/breakdown determination process;

FIG. 17 is a flowchart illustrating an example of an interference determination process;

FIGS. 18A and 18B are schematic diagrams illustrating an example of simulation results;

FIGS. 19A and 19B schematic diagrams illustrating an example of the simulation results; and

FIG. 20 is a block diagram illustrating an example of hardware of a communication device that implements an AP.

### DESCRIPTION OF EMBODIMENT

Preferred embodiments of the present invention will be explained with reference to accompanying drawings. The disclosed technology is not limited to the embodiments described below.

Wireless Communication System 10

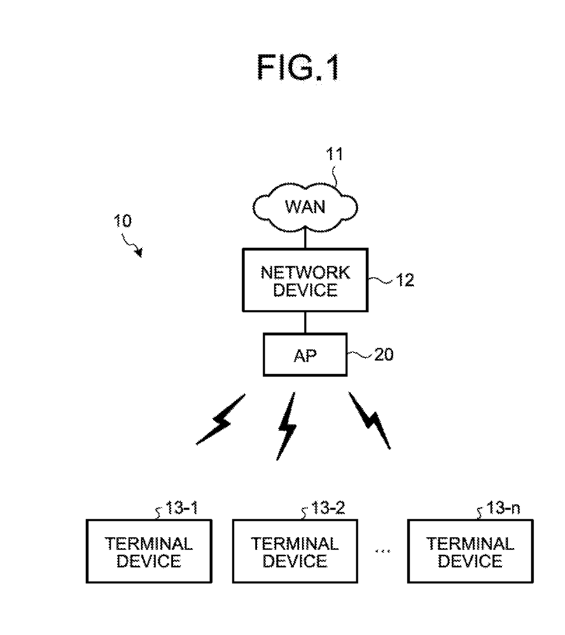

FIG. 1 is a schematic diagram illustrating an example of a wireless communication system 10. The wireless communication system 10 according to the embodiment includes an access point (AP) 20 and a plurality of terminal devices 13-1 to 13-n. The AP 20 is connected to a core network, such as, a wide area network (WAN) 11, via a network device 12, such as a router or the like. The AP 20 performs wireless communication with the terminal devices 13-1 to 13-n on the basis of the wireless LAN. Furthermore, in a description below, if there is no need to distinguish among each of the plurality of the terminal devices 13-1 to 13-n, the terminal devices 13-1 to 13-n is referred to as a terminal device 13. The AP 20 is an example of a wireless communication device.

The AP 20 transmits a data packet received from the terminal device 13 to the network device 12. Furthermore, the AP 20 transmits the data packet received from the network device 12 to the terminal device 13 by using the wireless communication performed on the basis of the wireless LAN standard. If the network device 12 receives a data packet from the AP 20, the network device 12 transmits, on the basis of the destination of the received data packet, the received data packet to the WAN 11. Furthermore, if the network device 12 receives a data packet addressed to the AP 20 or the terminal device 13 from the WAN 11, the network device 12 transmits the received data packet to the AP 20.

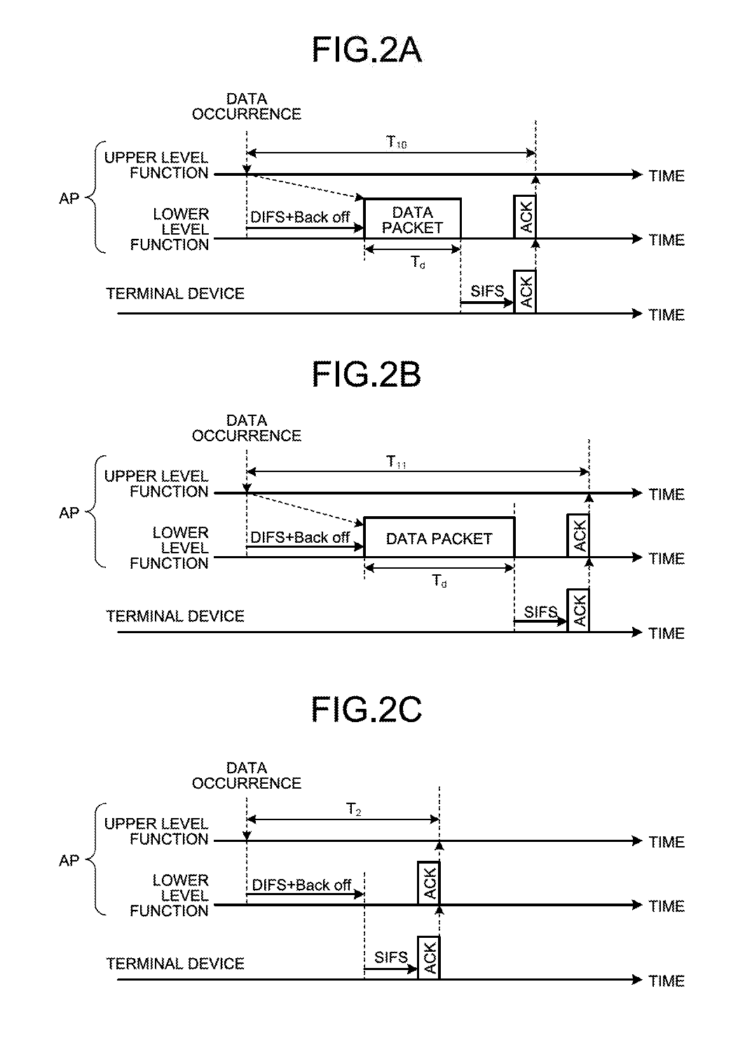

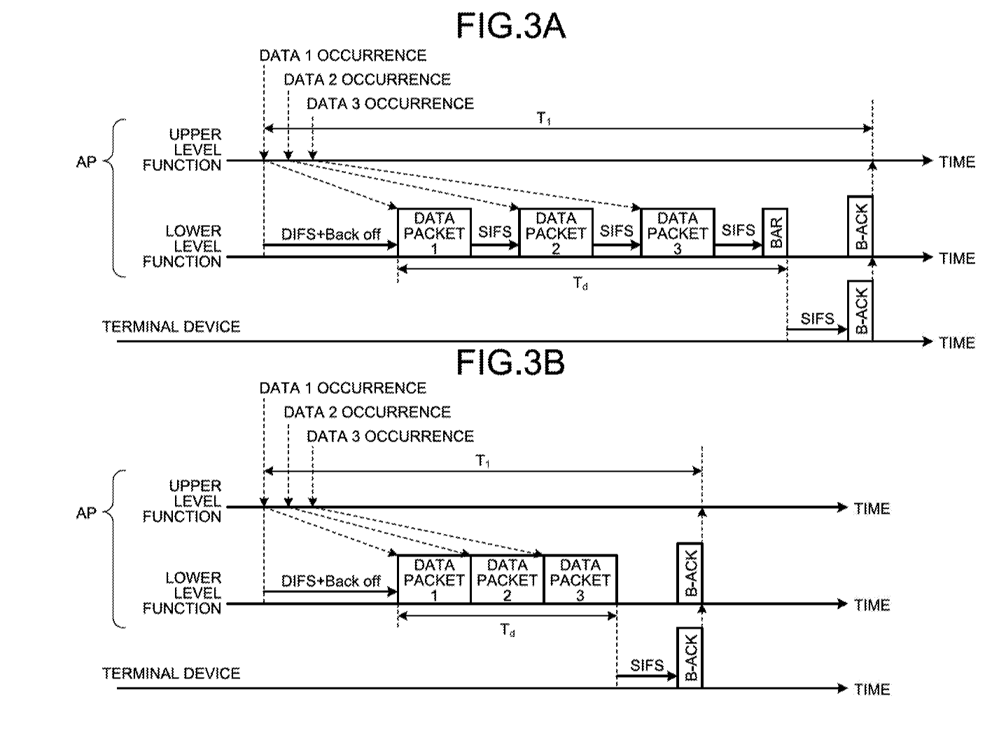

In the embodiment, the AP 20 measures first time that is the amount of time from when transmission of a data packet is instructed from the upper level function in the AP 20 to the lower level function until when the upper level function detects the reception of a response packet with respect to the subject data packet. Then, the AP 20 calculates second response time by subtracting a packet length, which is a temporal length of the data packet transmitted from the AP 20 to the terminal device 13, from the measured first response time. Then, the AP 20 determines, on the basis of the calculated second response time, the presence or absence of interference. In the following, the first response time, the second response time, and the packet length will be described with reference to FIGS. 2 and 3. Furthermore, in the embodiment, the upper level function is a functional block that performs, for example, an application, whereas the lower level function is a functional block that performs a process of the media access control (MAC) layer in, for example, a wireless LAN.

FIGS. 2A to 2B and FIGS. 3A and 3B are schematic diagrams each illustrating an example of first response time. Because the transmission delay on the basis of the distance between the AP 20 and the terminal device 13 is very smaller than the packet length of a data packet or the transmission standby time of the data packet, the transmission delay is omitted in FIGS. 2A to 2B and FIGS. 3A and 3B.

FIGS. 2A to 2B illustrate examples in which the first response time varies due to a change in a modulation and coding scheme (MCS). For example, as illustrated in FIG. 2A, when data targeted for transmission occurs, the upper level function in the AP 20 transmits a data packet that includes therein the subject data to the lower level function. When the lower level function receives the data packet from the upper level function, the lower level function transmits the subject data packet to the terminal device 13 after having waited for the first time period. In the first time period, a Distributed Inter Frame Space (DIFS) and a back off time period are included. The data packet is encoded and modulated on the basis of a predetermined MCS. The symbol T_{d} indicates the packet length that is the temporal length of the data packet.

The terminal device 13 receives the data packet transmitted from the AP 20 and transmits, after the elapse of a second time period since the subject data packet has been received, a response packet with respect to the received data packet to the AP 20. In the second time period, for example, Short Inter Frame Space (SIFS) is included. In a description below, the response packet is referred to as an ACK packet. The ACK packet transmitted from the terminal device 13 is received by the lower level function in the AP 20 and is transmitted to the upper level function. For example, in the example illustrated in FIG. 2A, the time that is the amount of time from when transmission of a data packet is instructed from the upper level function to the lower level function until when the upper level function detects the reception of the ACK packet with respect to the subject data packet is first response time T₁₀.

The AP 20 according to the embodiment appropriately changes the MCS in accordance with the communication environment between the AP 20 and the terminal device 13. Thus, if the communication environment between the AP 20 and the terminal device 13 becomes degraded, by changing to the MCS having strong error resilience, the packet length T_{d} of the data packet is increased. In the example illustrated in FIG. 2B, the MCS having error resilience stronger than that of the MCS of the data packet illustrated in FIG. 2A is used and the packet length T_{d} of the data packet illustrated in FIG. 2B is longer than the packet length T_{d} of the data packet illustrated in FIG. 2A. Consequently, for example, first response time T₁₁ illustrated in FIG. 2B is longer than, for example, the first response time T₁₀ illustrated in FIG. 2A.

At this time, if the AP 20 or the terminal device 13 receives interference radio waves, retransmission of a data packet is performed due to a reception failure of the data packet or the ACK packet and the length of the first response time is increased. If the data length T_{d} of the data packet is the fixed length, it is possible to determine the presence or absence of interference on the basis of the variation in the first response time. However, as indicated by, for example, illustrated in FIGS. 2A and 2B, if the MCS has been appropriately changed, the first response time is also changed due to a change in the MCS. Furthermore, if a data packet with a given size is used, the first response time is also changed in accordance with the size of the data packet. Consequently, it is difficult to accurately determine the presence or absence of interference by using only the first response time.

In contrast, the AP 20 according to the embodiment calculates second response time T₂ by subtracting the time of the packet length T_{d} of the data packet from the first response time. Consequently, in the second response time T₂, for example, as illustrated in FIG. 2C, the first time period that includes therein the DIFS and the back off time period, the second time period that includes therein the SIFS, and the packet length of the ACK packet are included. Then, the AP 20 determines, on the basis of the calculated second response time T₂, the presence or absence of interference. In the second response time T₂, for example, as illustrated in FIG. 2C, the time of the data length T_{d} of the data packet is not included. Thus, by determining the presence or absence of the interference on the basis of the second response time T₂, the AP 20 can determine the presence or absence of the interference without being affected by the variation in the data length T_{d} of the data packet due to a change in the MCS or the like.

Furthermore, the first time period or the second time period is extended if interference radio waves are detected due to carrier sense. Furthermore, the packet length of the ACK packet is substantially a fixed length. Consequently, if interference occurs, the length of the second response time T₂ varies. Thus, by determining the presence or absence of interference on the basis of the variation in the length of the second response time T₂, the AP 20 can accurately determine the presence or absence of interference.

Furthermore, the packet length T_{d} of the data packet also varies due to, in addition to the MCS, the number of multiplexed streams due to Multiple Input Multiple Output (MIMO) or the number of multiplexed bands due to channel bonding. the packet length T_{d} is calculated on the basis of, for example, Equation (1) below, where the transmission rate determined by the MCS is represented by R_{M}, the number of multiplexed streams due to MIMO is represented by N_{M}, the number of multiplexed bands due to channel bonding is represented by N_{C}, and the data size of the data packet is represented by D. Furthermore, in the wireless LAN standard in which the function of the MIMO or channel bonding is not supported, N_{M} and N_{C} become 1.

T_{d}=D/(R_{M}×N_{M}×N_{C}) (1)

Furthermore, the wireless LAN has a function called packet aggregation. In the packet aggregation, a plurality of data packets is collectively transmitted and a single ACK packet is transmitted with respect to the plurality of the collectively transmitted data packets. FIGS. 3A and 3B illustrate the first response time T₁ in the communication performed by using packet aggregation and a block ACK. Furthermore, in illustrated in FIG. 3A, as an example of the block ACK mode, an Explicit block ACK that uses a Block Ack Request (BAR) packet is illustrated. Furthermore, the packet aggregation exemplified in FIGS. 3A and 3B is used, for example, IEEE 802. 11e, or the like.

In packet aggregation, for example, as illustrated in FIG. 3A, the operation is performed when transmission of a plurality of the data packets is instructed from the upper level function within predetermined time. The lower level function starts the transmission of a data packet 1 after the elapse of the first time period since the transmission of the data packet 1 that includes therein data 1 was instructed from the upper level function first time. Then, the lower level function starts the transmission of a data packet 2 that is instructed from the upper level function subsequently to the data packet 1 after the elapse of the second time period from the end of the transmission of the data packet 1. In this way, in the packet aggregation illustrated in FIG. 3A, each of the data packets are continuously transmitted and spaced the second time period apart.

Then, if the transmission of data packet 3 that was instructed from the upper level function last time has been ended in the predetermined time, the lower level function transmits a BAR packet after the elapse of the second time period from the end of the transmission.

After the elapse of the second time period since the BAR packet has been received, the terminal device 13 transmits, to the AP 20, the block ACK (B-ACK) packet that indicates the reception status of the received data packets up to now. The block ACK packet transmitted from the terminal device 13 is received by the lower level function in the AP 20 and is transmitted to the upper level function. For example, in the example illustrated in FIG. 3A, the time that is the amount of time from when the transmission of the top data packet 1 that is targeted for the packet aggregation is instructed from the upper level function to the lower level function until when the upper level function detects the reception of the block ACK packet is the first response time T₁.

The packet length T_{d} illustrated in FIG. 3A is calculated on the basis of, for example, Equation (2) below by using data size Dₛ that is the sum total of the continuously transmitted data packets, the number of continuously transmitted data packets N_{D}, the data size D_{B} of the BAR packet, and the second time period T_{S}.

T_{d}={(Dₛ+D_{B})/(R_{M}×N_{M}×N_{C})}+N_{D}×T_{S} (2)

The AP 20 can calculate the second response time T₂ illustrated in FIG. 2C by using the time of packet length T_{d} calculated on the basis of Equation (2) above from the first response time T₁ illustrated in FIG. 3A. Furthermore, whether or not the block ACK is used is specified by a bit included in the header of the data packet.

Furthermore, in the block ACK mode, in addition to the Explicit block ACK that uses the BAR packet, an Implicit block ACK that does not use the BAR packet is also present. As the block ACK mode, which one of the Explicit block ACK and the Implicit block ACK is used is specified by a bit included in the header of the data packet. In the packet aggregation that is used in combination with the Implicit block ACK, for example, as illustrated in FIG. 3B, a plurality of the data packets are concatenated and transmitted. The packet aggregation and the Implicit block ACK with the mode illustrated in FIG. 3B are used by, for example, IEEE 802.11n, IEEE 802.11ac, or the like. In illustrated in FIG. 3B, the first response time T₁ when both the packet aggregation in a mode in which a plurality of data packets are concatenated and transmitted and the Explicit block ACK are used is exemplified.

The packet length T_{d} illustrated in FIG. 3B is calculated on the basis of, for example, Equation (3) below, where the data size of the sum total of the concatenated and transmitted data packets is represented by Dₛ.

T_{d}={Dₛ/(R_{M}×N_{M}×N_{C})} (3)

The AP 20 can calculate the second response time T₂ illustrated in FIG. 2C by subtracting the time of the packet length T_{d} calculated on the basis of Equation (3) above from the first response time T₁ illustrated in FIG. 3B.

AP 20

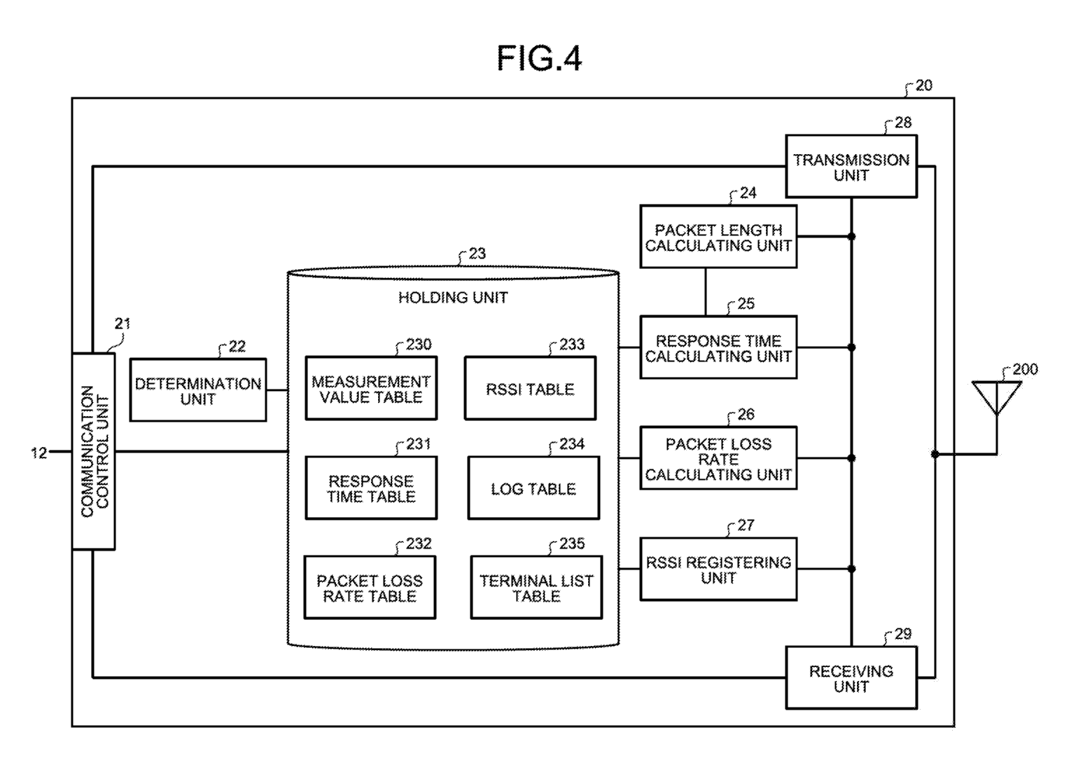

FIG. 4 is a block diagram illustrating an example of the AP 20. The AP 20 includes a communication control unit 21, a determination unit 22, a holding unit 23, a packet length calculating unit 24, a response time calculating unit 25, a packet loss rate calculating unit 26, an RSSI registering unit 27, a transmission unit 28, a receiving unit 29, and an antenna 200. The upper level functions illustrated in FIGS. 2 and 3 are implemented by, for example, the communication control unit 21 and the response time calculating unit 25. Furthermore, the lower level functions illustrated in FIGS. 2 and 3 are implemented by, for example, the transmission unit 28 and the receiving unit 29. The holding unit 23 includes a measurement value table 230, a response time table 231, a packet loss rate table 232, an RSSI table 233, a log table 234, and a terminal list table 235.

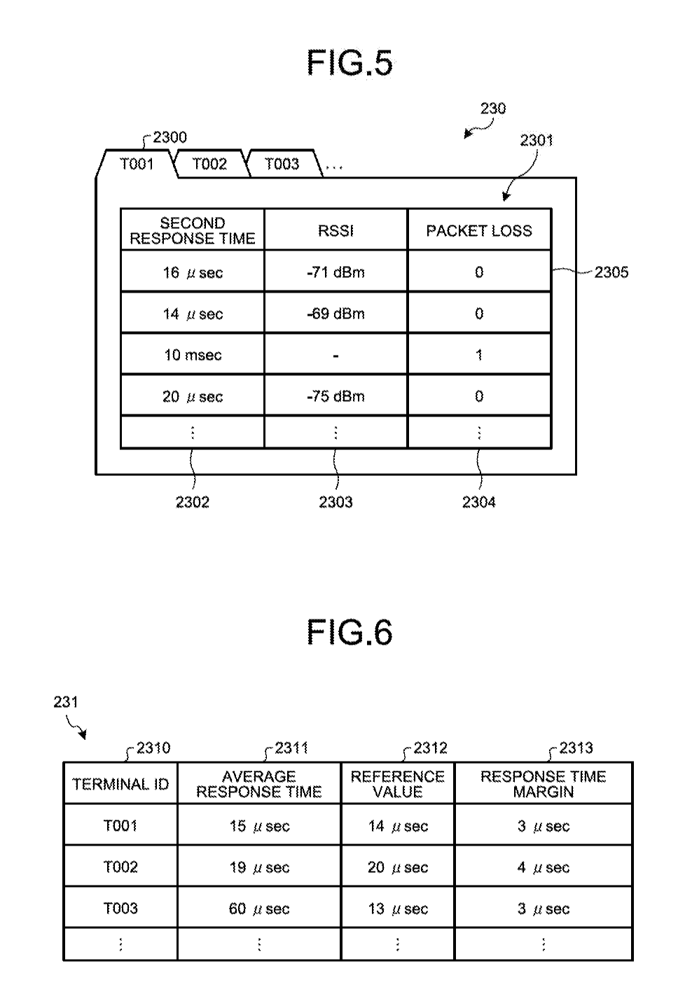

FIG. 5 is a schematic diagram illustrating an example of the measurement value table 230. In the measurement value table 230, for example, as illustrated in FIG. 5, a separate table 2301 is stored for each terminal ID 2300 that identifies each of the terminal devices 13. The terminal ID 2300 is the MAC address of, for example, the terminal device 13. In each of the separate tables 2301, a plurality of records 2305 including second response time 2302, an RSSI 2303, and a packet loss 2304 are stored.

As described with reference to FIGS. 2 and 3, the second response time 2302 is the time obtained by subtracting the packet length T_{d} from the first response time T₁. The RSSI 2303 is the received power at the time when the AP 20 receives the data packet or the ACK packet transmitted from the terminal device 13. The packet loss 2304 is information indicating whether the AP 20 has determined the packet loss because the AP 20 did not receive the ACK packet with respect to the data packet transmitted to the terminal device 13. If the AP 20 receives the ACK packet with respect to the data packet that is transmitted to the terminal device 13, 0 is stored in the packet loss 2304 indicating that the packet loss has not occurred. In contrast, if the AP 20 does not receive the ACK packet with respect to the data packet that is transmitted to the terminal device 13, 1 is stored in the packet loss 2304 indicating that the packet loss has occurred.

Every time the AP 20 transmits a packet to the terminal device 13, the record 2305 is created in the separate table 2301 that is associated with the terminal ID of the subject terminal device 13. Then, if the AP 20 receives the ACK packet from the subject terminal device 13, the measurement values are registered in the second response time 2302 and the RSSI 2303 in the created record 2305 and 0 is registered in the packet loss 2304. In contrast, if the AP 20 does not receive the ACK packet from the terminal device 13, 1 is registered in the packet loss 2304 in the created record 2305, the time taken to determine a packet loss is registered in the second response time 2302, and the RSSI 2303 becomes a blank space.

FIG. 6 is a schematic diagram illustrating an example of the response time table 231. In the response time table 231, for example, as illustrated in FIG. 6, a terminal ID 2310, an average response time 2311, a reference value 2312, and a response time margin 2313 are stored in an associated manner. The average response time 2311 is the average value of the second response time. The reference value 2312 is the value that is the criterion of the average response time 2311. The response time margin 2313 is the value indicating the range of variation in the average response time that is allowed with respect to the reference value 2312. The time obtained by adding the response time margin 2313 to the reference value 2312 is used as a threshold at the time of determination of interference.

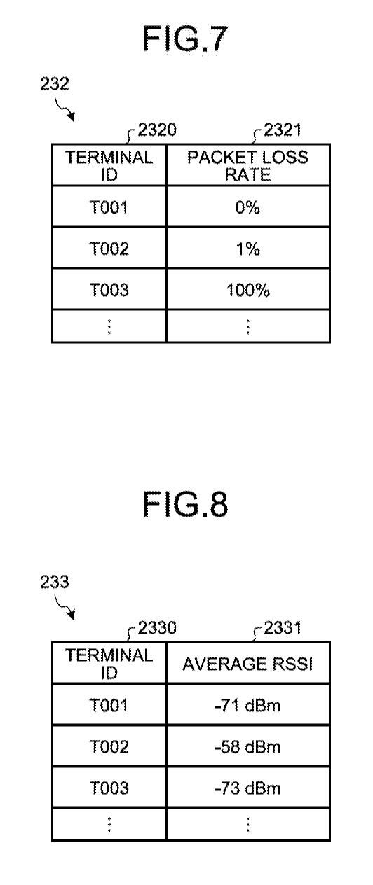

FIG. 7 is a schematic diagram illustrating an example of the packet loss rate table 232. In the packet loss rate table 232, as illustrated in, for example, FIG. 7, a packet loss rate 2321 is stored by being associated with a terminal ID 2320. The packet loss rate 2321 is the rate of a data packet indicating the ACK packet that is not received in the AP 20 from among the data packets transmitted from the AP 20.

FIG. 8 is a schematic diagram illustrating an example of the RSSI table 233. In the RSSI table 233, for example, as illustrated in FIG. 8, an average RSSI 2331 is stored by being associated with a terminal ID 2330. The average RSSI 2331 is the average value of the RSSIs measured in the AP 20 when the AP 20 receives the packets transmitted from the terminal device 13.

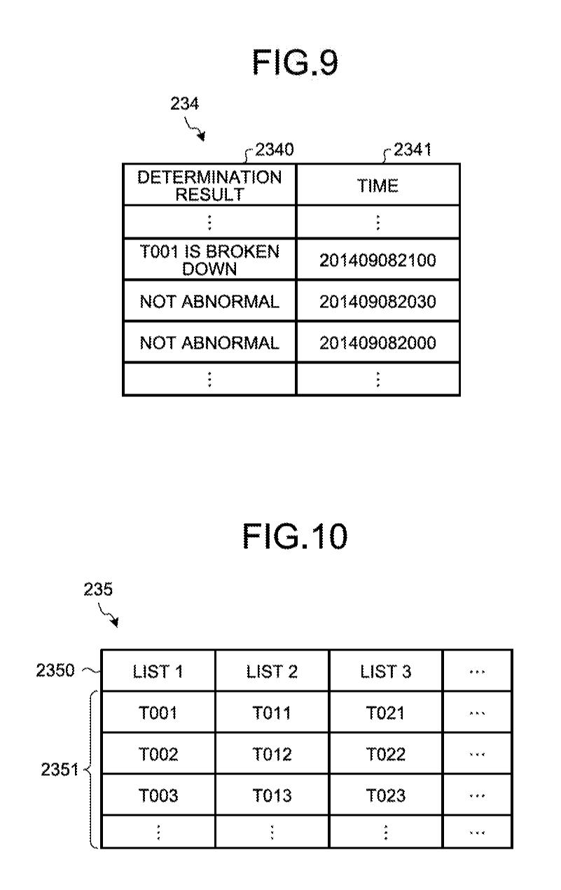

FIG. 9 is a schematic diagram illustrating an example of the log table 234. In the log table 234, for example, as illustrated in FIG. 9, a determination result 2340 and time 2341 are stored in an associated manner. The determination result 2340 indicates the determination result of a cause of a failure. The time 2341 indicates the time at which the determination result 2340 is registered in the log table 234.

FIG. 10 is a schematic diagram illustrating an example of the terminal list table 235. In the terminal list table 235, for example, as illustrated in FIG. 10, terminal lists 2351 are stored for each list name 2350. The list name 2350 is the information for identifying each of the terminal lists 2351. In each of the terminal lists 2351, the terminal ID is registered.

A description will be continued by referring back to FIG. 4. If the transmission unit 28 is instructed from the communication control unit 21 to transmit a data packet, the transmission unit 28 holds, in an associated manner, the time at which the transmission of the data packet is instructed and the terminal ID of the terminal device 13 that is the destination of the data packet. Then, after the transmission unit 28 waits for the first time period, the transmission unit 28 transmits, as unicast, the instructed data packet to the destination terminal device 13 via the antenna 200. At this time, if packet aggregation is performed with the destination terminal device 13, the transmission unit 28 transmits, to the destination terminal device 13, a plurality of the data packets that are instructed by the communication control unit 21 to be transmitted continuously or concatenated manner in a predetermined time period. Furthermore, the transmission unit 28 also transmits, to the packet length calculating unit 24, the data packets that have been transmitted to the destination terminal device 13.

Furthermore, if the transmission unit 28 is instructed from the response time calculating unit 25 to transmit a data packet together with the terminal ID, the transmission unit 28 transmits the subject data packet to the terminal device 13 that is associated with the subject terminal ID.

Furthermore, if the receiving unit 29 does not receive an ACK packet from the destination terminal device 13 within the predetermined time after the data packet has been transmitted via the antenna 200, the transmission unit 28 retransmits the data packet. Then, if the number of retransmissions reaches a predetermined number of times (for example, five times), the transmission unit 28 notifies the response time calculating unit 25 and the packet loss rate calculating unit 26 of the packet loss together with the terminal ID of the destination terminal device 13.

Furthermore, if the transmission unit 28 receives an inquiry including the terminal ID from the response time calculating unit 25, the transmission unit 28 determines whether a data packet (hereinafter, referred to as a specific packet) addressed to terminal device 13 with the terminal ID that is included in the subject inquiry is included in a data packet that is waiting for transmission. If no specific packet is present in a data packet that is waiting for transmission, the transmission unit 28 transmits the information indicating this status to the response time calculating unit 25.

In contrast, a specific packet is present in the data packet that is waiting for transmission, the transmission unit 28 transmits, to the packet length calculating unit 24, the time that is related to the transmission of the data included in the specific packet and that is instructed from the communication control unit 21. At this time, if the specific packet is the data packet that is included in the plurality of the data packets that are continuously transmitted or that are transmitted in a concatenated manner due to packet aggregation, the following process is performed. Namely, the transmission unit 28 transmits, to the response time calculating unit 25, the time that is related to the transmission of the top data packet included in the plurality of the data packets continuously transmitted or transmitted in a concatenated manner and that is instructed from the communication control unit 21.

If the receiving unit 29 receives a data packet via the antenna 200, the receiving unit 29 outputs the received data packet to the communication control unit 21. Furthermore, if the receiving unit 29 receives an ACK packet via the antenna 200, the receiving unit 29 outputs, to the response time calculating unit 25, the packet loss rate calculating unit 26, and the transmission unit 28, the terminal ID of the terminal device 13 that has transmitted the ACK packet. Furthermore, if the receiving unit 29 receives an ACK packet from the terminal device 13, the receiving unit 29 transmits, to the RSSI registering unit 27, the RSSI of the ACK packet together with the terminal ID of the terminal device 13 that is the transmission source of the ACK packet.

If the communication control unit 21 receives a packet from the network device 12, the communication control unit 21 transmits the received packet to the transmission unit 28 and instructs the transmission unit 28 to transmit the packet. Furthermore, if the communication control unit 21 receives a packet from the receiving unit 29, the communication control unit 21 transmits the received packet to the network device 12.

If the packet length calculating unit 24 receives a request to calculate the packet length including the terminal ID from the response time calculating unit 25, the packet length calculating unit 24 refers to the data packet that is output from the transmission unit 28 and calculates the packet length T_{d} of the data packet addressed to the terminal device 13 that is associated with the subject terminal ID. Then, the packet length calculating unit 24 transmits the calculated packet length T_{d} to the response time calculating unit 25.

The packet length calculating unit 24 refers to the header of the data packet output from the transmission unit 28 and specifies the data size D, the transmission rate R_{M} determined by the MCS, the number of multiplexed streams N_{M} due to MIMO, and the number of multiplexed bands N_{C} due to channel bonding. Furthermore, the packet length calculating unit 24 refers to the wireless header of the data packet output from the transmission unit 28 and determines whether an HT-SIG or VHT-SIG field is present in the wireless header. If no HT-SIG or VHT-SIG field is present in the wireless header, the data packet is the data packet supported by the wireless LAN standard, such as the IEEE 802.11a standard, or the like. The packet length calculating unit 24 calculates the packet length T_{d} on the basis of, for example, Equation (1) described above.

In contrast, if the block ACK mode is not the Explicit block ACK, i.e., if the block ACK mode is the Implicit block ACK, the packet length calculating unit 24 calculates the packet length T_{d} on the basis of, for example, Equation (3) described above.

Furthermore, if the HT-SIG or VHT-SIG field is present in the wireless header, the packet length calculating unit 24 determines whether the VHT field is present in the MAC header. If the VHT field is present in the MAC header, the data packet is the data packet supported by the wireless LAN standard, such as the IEEE 802.11ac standard, or the like, and packet aggregation is available by default. If the VHT field is present in the MAC header, the packet length calculating unit 24 refers to the QoS field in the MAC header and determines whether the block ACK mode is the Explicit block ACK. If the block ACK mode is the Explicit block ACK, the packet length calculating unit 24 refers to the header of the BAR packet and specifies the data size D_{B} of the BAR packet. Then, the packet length calculating unit 24 calculates the packet length T_{d} on the basis of, for example, Equation (2) described above.

In contrast, if the block ACK mode is not the Explicit block ACK, i.e., if the block ACK mode is the Implicit block ACK, the packet length calculating unit 24 calculates the packet length T_{d} on the basis of, for example, Equation (3) described above.

Furthermore, if no VHT field is present in the MAC header, the data packet is the data packet supported by the wireless LAN standard, such as the IEEE 802.11n standard, or the like, and the packet aggregation is option. If no VHT field is present in the MAC header, the packet length calculating unit 24 refers to the bit in the HT-SIG field and determines whether the packet aggregation is available. If the packet aggregation is unavailable, the packet length calculating unit 24 calculates the packet length T_{d} on the basis of, for example, Equation (1) described above.

In contrast, if the packet aggregation is available, the packet length calculating unit 24 refers to the QoS field in the MAC header and determines whether the block ACK mode is the Explicit block ACK. If the block ACK mode is the Explicit block ACK, the packet length calculating unit 24 refers to the header of the BAR packet and specifies the data size D_{B} of the BAR packet. Then, the packet length calculating unit 24 calculates the packet length T_{d} on the basis of, for example, Equation (2) described above.

In contrast, if the block ACK mode is not the Explicit block ACK, i.e., if the block ACK mode is the Implicit block ACK, the packet length calculating unit 24 calculates the packet length T_{d} on the basis of, for example, Equation (3) described above.

The response time calculating unit 25 measures, for each of the terminal devices 13, the first response time that is the amount of time from when the transmission of the data packet addressed to the terminal device 13 is instructed by the transmission unit 28 until when the ACK packet with respect to the subject data packet is received. For example, the response time calculating unit 25 transmits an inquiry that includes therein the terminal ID of the terminal device 13 to the transmission unit 28. If the data packet that is addressed to the terminal device 13 associated with the terminal ID included in the inquiry is included in the data packet that is waiting for transmission, the transmission unit 28 transmits, as a reply to the response time calculating unit 25, the time at which the data included in the data packet is instructed by the communication control unit 21. The response time calculating unit 25 specifies the time of the transmission performed as a reply from the transmission unit 28 as the start time of the first response time.

In contrast, if a reply indicating that data packet that is waiting for transmission is not present is transmitted from the transmission unit 28, the response time calculating unit 25 instructs the transmission unit 28 to transmit the data packet together with the terminal ID. Then, the response time calculating unit 25 specifies the time at which the transmission of the data packet has been instructed to the transmission unit 28 as the start time of the first response time.

Then, the response time calculating unit 25 specifies the time at which the terminal ID of the terminal device 13 that is the transmission source of the ACK packet is received from the receiving unit 29 as the end time of the first response time. Then, the response time calculating unit 25 specifies the time that is the amount of time from the start time to the end time of the first response time as the first response time.

Then, the response time calculating unit 25 transmits a request to calculate the packet length including the terminal ID to the packet length calculating unit 24 and acquires the packet length form the packet length calculating unit 24. Then, the response time calculating unit 25 calculates the second response time by subtracting the packet length acquired from the packet length calculating unit 24 from the specified first response time.

Then, the response time calculating unit 25 specifies, in the measurement value table 230 in the holding unit 23, the separate table 2301 associated with the terminal ID of the terminal device 13. Then, the response time calculating unit 25 newly creates the record 2305 in the specified separate table 2301 and registers the calculated second response time in the created record 2305. Furthermore, if a packet loss is notified from the transmission unit 28, the response time calculating unit 25 calculates the time that is the amount of time until the packet loss is notified as the second response time and registers the calculated response time in the record 2305 in the separate table 2301.

Furthermore, the response time calculating unit 25 refers, for each of the terminal devices 13, the separate table 2301 in the measurement value table 230, extracts a predetermined number of pieces of the second response time in the order the pieces of the second response time are newly registered, averages the extracted pieces of the second response time, and calculates the average response time. Then, the response time calculating unit 25 updates, for each of the terminal devices 13, the average response time 2311 in the response time table 231 to the average response time. In the embodiment, the response time calculating unit 25 calculates the average response time for each of the terminal devices 13 by averaging, for example, several tens of rows of the second response time in the order the pieces of the second response time are newly registered.

Furthermore, the response time calculating unit 25 registers, for each of the terminal devices 13, the calculated average value of the second response time in the reference value 2312 in the response time table 231 as the reference value of the second response time. Furthermore, the response time calculating unit 25 calculates, for each of the terminal devices 13, variation in the calculated second response time and registers the calculated variation in the response time margin 2313 in the response time table 231. The value of the response time margin 2313 may also be, for example, standard deviation σ or twice as much as the standard deviation σ of the second response time.

Here, regarding the second response time illustrated in FIG. 2C, the back off time period included in the first time period is randomly selected in the range of few μ seconds to several tens of μ seconds. Thus, the second response time that includes therein the first time period has a predetermined range of variation. Furthermore, if the other terminal device 13 is in communication, the first time period is extended. Thus, in a heavy communication traffic environment, the range of variation in the second response time may sometimes be increased. Thus, it is preferable that the response time calculating unit 25 perform, regarding each of the terminal devices 13, a process of creating a reference value of the second response time in a low communication traffic environment (for example, late night hours, etc.).

If the terminal ID of the terminal device 13 that is the transmission source of the ACK packet is notified by the receiving unit 29, the packet loss rate calculating unit 26 refers to the measurement value table 230 and specifies the separate table 2301 that is associated with the notified terminal ID. Then, the packet loss rate calculating unit 26 registers, in the specified separate table 2301, 0 indicating that a packet loss did not occur in the column of the packet loss 2304 in the newly created record 2305.

In contrast, if the packet loss is notified from the transmission unit 28 together with the terminal ID of the terminal device 13, the packet loss rate calculating unit 26 refers to the measurement value table 230 and specifies the separate table 2301 that is associated with the notified terminal ID. Then, the packet loss rate calculating unit 26 registers, in the specified separate table 2301, 1 indicating that a packet loss has occurred in the column of the packet loss 2304 in the record 2305.

Furthermore, the packet loss rate calculating unit 26 refers to the separate table 2301 in the measurement value table 230 for each of the terminal devices 13, extracts the values of the predetermined number of packet losses in the order of the packet losses that are newly registered, and calculates the packet loss rate by averaging the extracted values. Then, the packet loss rate calculating unit 26 updates, for each of the terminal devices 13, the packet loss rate 2321 in the packet loss rate table 232 to the calculated packet loss rate. In the embodiment, the packet loss rate calculating unit 26 calculates the packet loss rate for each of the terminal devices 13 by averaging the values of, for example, several tens of packet losses in the newly registered order.

If the RSSI registering unit 27 receives the RSSI together with the terminal ID of the terminal device 13 from the receiving unit 29, the RSSI registering unit 27 refers to the measurement value table 230 and specifies the separate table 2301 associated with the received terminal ID. Then, the RSSI registering unit 27 registers, in the specified separate table 2301, the value of the RSSI received from the receiving unit 29 in the column of the RSSI 2303 in the newly created record 2305.

Furthermore, the RSSI registering unit 27 refers to the separate table 2301 in the measurement value table 230 for each of the terminal devices 13, extracts a predetermined number of RSSIs in the newly registered order, and calculates the average RSSI by averaging the extracted RSSIs. Then, the RSSI registering unit 27 updates, for each of the terminal devices 13, the average RSSI 2331 in the RSSI table 233 to the calculated average RSSI. In the embodiment, the RSSI registering unit 27 calculates the average RSSI by averaging, for example, several tens of RSSIs in the newly registered order for each of the terminal devices 13. Furthermore, in addition to the ACK packet, the average RSSI may also be calculated by using the RSSI measured when the data packet transmitted from the terminal device 13 is received.

The determination unit 22 refers to the separate table 2301 in the measurement value table 230 for each of the terminal devices 13 at a predetermined timing (for example, every few hours) and specifies the terminal device 13 that has a high possibility of being affected by fading. For example, the determination unit 22 specifies the terminal device 13 having the average RSSI equal to or less than a predetermined threshold as the terminal device 13 that has a high possibility of being affected by fading. Then, the determination unit 22 registers the terminal ID of the specified terminal device 13 in a list 1 in the terminal list table 235. The terminal device 13 with the terminal ID that has been registered in the list 1 is excluded from the target for the determination of the presence or absence of interference.

Here, in an environment in which fading is great, received power of the data packet or the ACK packet greatly varies. Thus, retransmission of the data packet occurs and thus the second response time may sometimes be long. Accordingly, if the second response time varies, it is difficult to distinguish whether this state is due to fading or interference. Thus, in the embodiment, the terminal device 13 that is affected by fading is excluded from the terminal devices 13 targeted for the determination of the presence or absence of interference. Consequently, the AP 20 can perform determination of the presence or absence interference by targeting for the terminal device 13 that has a low possibility of being affected by fading and can perform the determination of the presence or absence interference with high accuracy.

Furthermore, the determination unit 22 refers to each of the tables in the holding unit 23 at a predetermined timing (for example, every 10 minutes) and performs a failure determination process. In the failure determination process, if the terminal device 13 that made an abnormal response with respect to the data packet transmitted by the transmission unit 28 is one of the terminal devices 13 that are destinations of the data packets, the determination unit 22 determines that this state is a failure of the subject one of the terminal devices 13. Furthermore, in the failure determination process, if the terminal devices 13 each made an abnormal response with respect to the data packet transmitted by the transmission unit 28 are all of the terminal devices 13 that are destinations of the data packets, the determination unit 22 determines that this state is a failure of the AP 20.

For example, in the failure determination process, the determination unit 22 refers to the packet loss rate table 232 and specifies the terminal device 13 having the packet loss rate P equal to or greater than a predetermined threshold Pₜₕ₁. In the embodiment, the predetermined threshold Pₜₕ₁ is, for example, 100%.

If the terminal device 13 having the packet loss rate P equal to or greater than the threshold Pₜₕ₁ is all of the terminal devices 13, the determination unit 22 determines that the cause of a failure is a breakdown or shielding of the AP 20. All of the terminal devices 13 mentioned here are all of the terminal devices 13 attributed to, for example, the AP 20. Furthermore, shielding of the AP 20 mentioned here is the state in which, for example, between any of the terminal devices 13, radio waves from the AP 20 do not arrive at the terminal devices 13 at the intensity available for communication and the radio waves from the terminal devices 13 do not arrive at the AP 20 at the intensity available for communication.

Furthermore, the terminal device 13 having the packet loss rate P equal to or greater than the threshold Pₜₕ₁ is one of the terminal devices 13, the determination unit 22 determines that a breakdown or shielding of the terminal devices 13 having the packet loss rate P equal to or greater than the threshold Pₜₕ₁ is the cause of the failure. Then, the determination unit 22 registers the determination result in the log table 234 in the holding unit 23 together with the time at which the determination has been performed.

At this time, if at least one of the terminal devices 13 having the packet loss rate P less than the threshold Pₜₕ₁ is present in the terminal devices 13 that are attributed to the AP 20, the AP 20 can determine that a breakdown or shielding does not occur. Furthermore, if the transmission unit 28 in the AP 20 is broken down, the data packets are not transmitted to all of the terminal devices 13. Furthermore, if the AP 20 shielded by a shielding substance, the transmitted data packet is not received by any one of the terminal devices 13. Furthermore, if the receiving unit 29 in the AP 20 is broken down, even if the transmission unit 28 in the AP 20 transmits the data packets, receiving the ACK packet transmitted from any one of the terminal devices 13 have failed. Consequently, if the AP 20 is broken down or is shielded, the packet loss rate P of all of the terminal devices 13 becomes equal to or greater than the threshold Pₜₕ₁.

Furthermore, if the packet loss rate P of all of the terminal devices 13 becomes equal to or greater than the threshold Pₜₕ₁, it is conceivable that all of the terminal devices 13 are simultaneously broken down or are shielded. However, the probability that all of the terminal devices 13 are simultaneously broken down or shielded is far lower than the probability that the single AP 20 is broken down or shielded. Consequently, in the embodiment, if the packet loss rate P of all of the terminal devices 13 becomes equal to or greater than the threshold Pₜₕ₁, the determination unit 22 determines the breakdown or shielding of the AP 20 is the cause of the failure.

In this way, by determining whether the terminal device 13 that made an abnormal response with respect to the data packet transmitted from the AP 20 is all of the terminal devices 13, the determination unit 22 can distinguish whether this state is a failure of the terminal device 13 or a failure of the AP 20. Consequently, even if a special measurement function is not provided to each of the terminal devices 13, the AP 20 can distinguish whether this state is a failure of the terminal device 13 or a failure of the AP 20.

Furthermore, if the determination unit 22 determines, in the failure determination process, that the state is not the breakdown or shielding of the AP 20, the determination unit 22 excludes the terminal device 13 having the terminal ID that is registered in the list 1 in the terminal list table 235 from the terminal devices 13 having the packet loss rate P that is less than the threshold Pₜₕ₁. Then, the determination unit 22 registers the terminal ID of the remaining terminal devices 13 in a list 4 in the terminal list table 235.

Then, the determination unit 22 refers to the response time table 231 and specifies the terminal device 13 having the average response time greater than the predetermined value from among the terminal devices 13 with the terminal ID registered in the list 4. Then, if the number of specified terminal devices 13 is equal to or greater than a predetermined percentage (for example, 90% or more) of the number of the terminal devices 13 having the terminal IDs registered in the list 4, the determination unit 22 determines that the state in which the AP 20 is subjected to interference is the cause of the failure. In contrast, if the number of specified terminal devices 13 is less than the predetermined percentage of the number of the terminal devices 13 having the terminal IDs registered in the list 4, the determination unit 22 determines that the state in which the specific terminal device 13 is subjected to interference is the cause of the failure. Then, the determination unit 22 registers the determination result in the log table 234 in the holding unit 23 together with the time at which the determination has been performed.

In this way, even if a special measurement function is not provided to each of the terminal devices 13, the AP 20 according to the embodiment can perform determination of the cause of a failure, such as distinguishing whether the device that is affected by interference radio waves is the AP 20 or the terminal devices 13. Furthermore, if one of the terminal devices 13 is affected by interference radio waves, even if a special measurement function is not provided to each of the terminal devices 13, the AP 20 can specify the terminal device 13 that is affected by interference radio waves. Consequently, it is possible to specify the position of the interference source from the arrangement of the terminal device 13 and the AP 20 that are affected by interference radio waves. Furthermore, the determination unit 22 according to the embodiment excludes the terminal device 13 having the terminal ID that is registered in the list 1 from the target for the determination of the cause of a failure as the terminal device 13 that has a high possibility of being affected by fading. Consequently, the determination unit 22 can perform determination of the cause of a failure by targeting for the terminal device 13 that has a low possibility of being affected by fading and can improve the accuracy of the determination of the cause of a failure.

Reference Value Creating Process

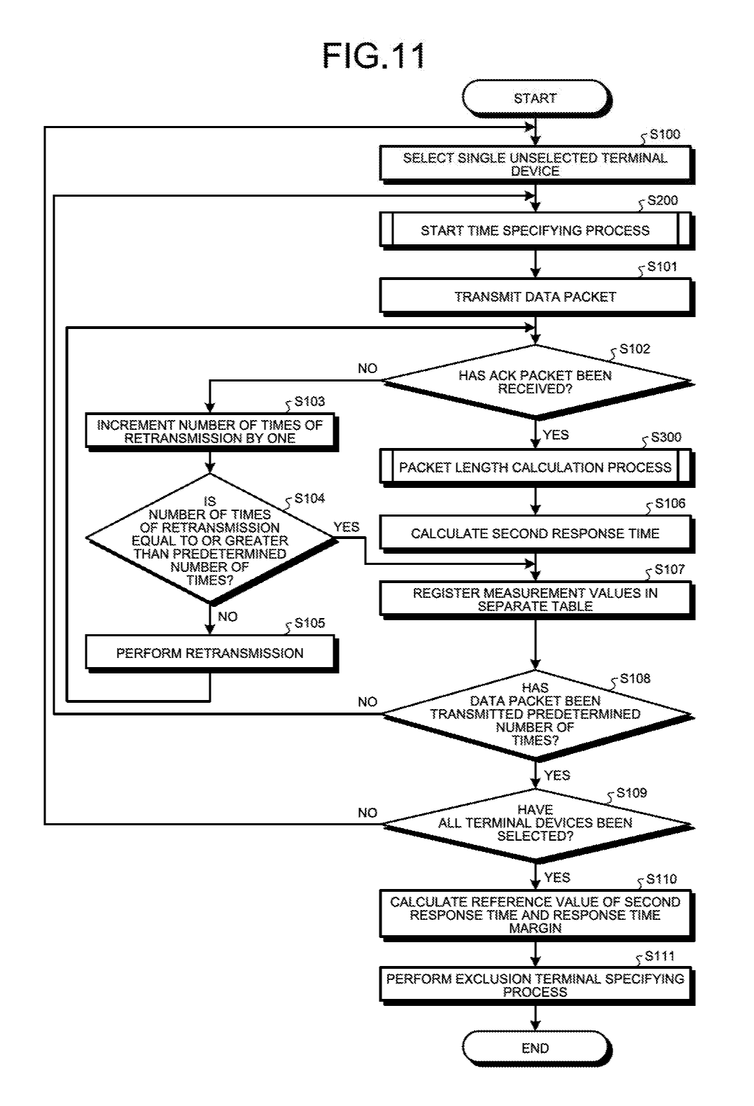

FIG. 11 is a flowchart illustrating an example of a reference value creating process. For example, in a time zone, such as late at night, in which the number of the terminal devices 13 that transmit and receive the data packets is small, the AP 20 performs the reference value creating process indicated by the flowchart.

First, the response time calculating unit 25 selects the single and unselected terminal device 13 from among the terminal devices 13 that are attributed to the AP 20 (Step S100). Then, the response time calculating unit 25 performs the start time specifying process that specifies the start time of the first response time regarding the selected terminal device 13 (Step S200).

Start Time Specifying Process

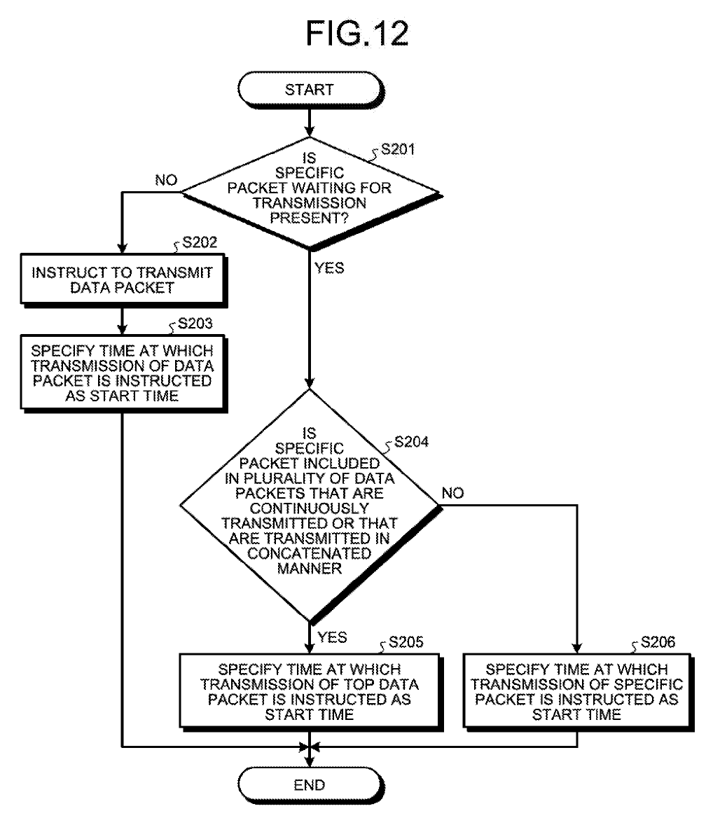

FIG. 12 is a flowchart illustrating an example of a start time specifying process.

First, the response time calculating unit 25 transmits an inquiry including the terminal ID of the terminal device 13 selected at Step S100 illustrated in FIG. 11 to the transmission unit 28. The transmission unit 28 determines whether, in the data packets that are waiting for transmission, a specific packet that is the data packet addressed to the terminal device 13 associated with the terminal ID included in the inquiry received by the response time calculating unit 25 is present (Step S201).

If no specific packet is present in the data packets that are waiting for transmission (No at Step S201), the transmission unit 28 transmits the information indicating this state to the response time calculating unit 25. The response time calculating unit 25 instructs the transmission unit 28 to transmit the data packet together with the terminal ID (Step S202). Then, the response time calculating unit 25 specifies the time at which the transmission of the data packet is instructed to the transmission unit 28 as the start time of the first response time (Step S203). Then, the AP 20 ends the start time specifying process indicated in the flowchart.

In contrast, if the specific packet is present in the data packets that are waiting for transmission (Yes at Step S201), the transmission unit 28 determines whether the specific packet is included in the plurality of data packets that are continuously transmitted or that are transmitted in a concatenated manner in packet aggregation (Step S204).

If the specific packet is included in the plurality of data packets that are continuously transmitted or that are transmitted in a concatenated manner in packet aggregation (Yes at Step S204), the transmission unit 28 performs the following process. Namely, the transmission unit 28 transmits, to the response time calculating unit 25, the time at which the transmission of the top data packet included in the plurality of the data packets that are continuously transmitted or that are transmitted in a concatenated manner is instructed to the communication control unit 21. The response time calculating unit 25 specifies the time received from the transmission unit 28 as the start time of the first response time (Step S205). Then, the AP 20 ends the start time specifying process indicated by the flowchart.

If the specific packet is not included in the plurality of data packets that are continuously transmitted or that are transmitted in a concatenated manner in packet aggregation (No at Step S204), the transmission unit 28 performs the following process. Namely, the transmission unit 28 transmits, to the response time calculating unit 25, the time at which the transmission of the specific packet is instructed to the communication control unit 21. The response time calculating unit 25 specifies the time received from the transmission unit 28 as the start time of the first response time (Step S206). Then, the AP 20 ends the start time specifying process indicated by the flowchart.

A description will be continued by referring back to FIG. 11. The transmission unit 28 transmits the data packet instructed from the communication control unit 21 or the response time calculating unit 25 (Step S101). Then, the receiving unit 29 determines whether the ACK packet has been received within the predetermined time after the transmission of the data packet (Step S102).

If the ACK packet has been received within the predetermined time (Yes at Step S102), the receiving unit 29 transmits, to the response time calculating unit 25, the packet loss rate calculating unit 26, and the transmission unit 28, the terminal ID of the terminal device 13 that has transmitted the ACK packet. Furthermore, the receiving unit 29 transmits, to the RSSI registering unit 27, the RSSI measured when the ACK packet is received together with the terminal ID of the terminal device 13 that is the transmission source of the received ACK packet. Then, the response time calculating unit 25 transmits, to the packet length calculating unit 24, a request to calculate the packet length including the terminal ID of the terminal device 13 selected at Step S100. Then, the AP 20 performs the packet length calculation process that calculates the packet length of the data packet transmitted at Step S101 (Step S300).

If the receiving unit 29 does not receive the ACK packet within the predetermined time (No at Step S102), the transmission unit 28 increments the number of times of retransmission by one (Step S103). Then, the transmission unit 28 determines whether the number of times of retransmission is equal to or greater than a predetermined number of times (Step S104). If the number of times of retransmission is less than the predetermined number of times (No at Step S104), the transmission unit 28 retransmits the data packet (Step S105) and the receiving unit 29 again performs the process indicated by Step S102.

In contrast, if the number of times of retransmission is equal to or greater than the predetermined number of times (Yes at Step S104), the transmission unit 28 notifies the response time calculating unit 25 of the packet loss of the data packet together with the terminal ID of the terminal device 13 that is the destination of the data packet. Then, the process indicated by Step S107 is performed.

Packet Length Calculation Process

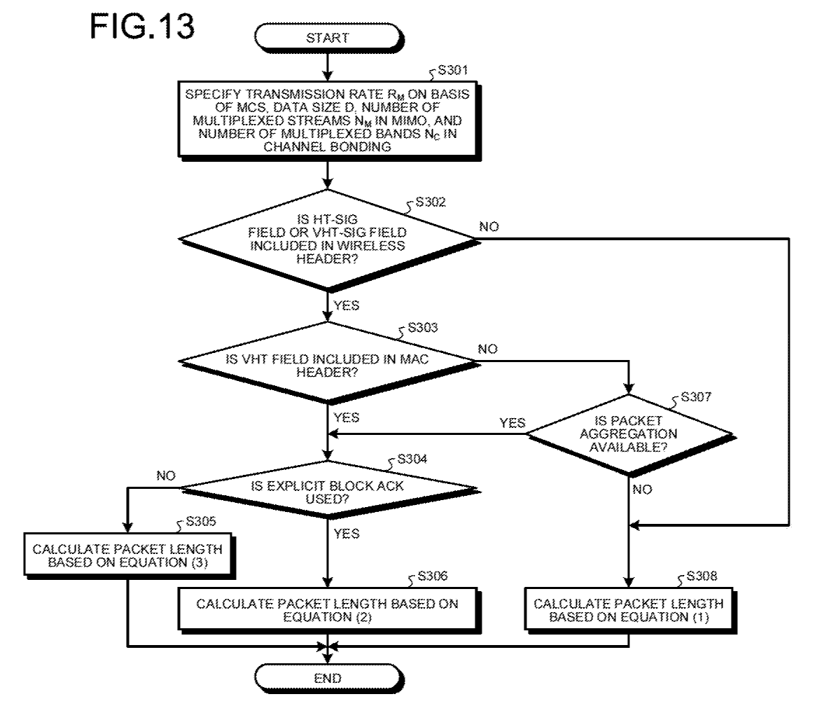

FIG. 13 is a flowchart illustrating an example of a packet length calculation process.

First, the packet length calculating unit 24 refers to the headers of the data packets output from the transmission unit 28. Then, the packet length calculating unit 24 specifies the transmission rate R_{M} determined on the basis of the MCS, the data size D of the data packets, the number of multiplexed streams N_{M} used in MIMO, and the number of multiplexed bands N_{C} due to channel bonding (Step S301). Then, the packet length calculating unit 24 refers to the wireless headers of the data packets output from the transmission unit 28 and determines whether the HT-SIG field or the VHT-SIG field is included in the wireless header (Step S302).

If the HT-SIG field or the VHT-SIG field is included in the wireless header (Yes at Step S302), the packet length calculating unit 24 determines whether the VHT field is included in the MAC header (Step S303). If the VHT field is included in the MAC header (Yes at Step S303), the packet length calculating unit 24 refers to the QoS field in the MAC header and determines whether the block ACK mode is the Explicit block ACK (Step S304).

If the block ACK mode is not the Explicit block ACK (No at Step S304), i.e., if the block ACK mode is the Implicit block ACK, the packet length calculating unit 24 calculates the packet length T_{d} on the basis of, for example, Equation (3) described above (Step S305). Then, the packet length calculating unit 24 transmits the calculated packet length T_{d} to the response time calculating unit 25. Then, the AP 20 ends the packet length calculation process indicated by the flowchart.

In contrast, if the block ACK mode is the Explicit block ACK (Yes at Step S304), by counting the number of headers of the data packets that are continuously transmitted, the packet length calculating unit 24 specifies the number of data packets N_{D} that are continuously transmitted. Then, the packet length calculating unit 24 refers to the header of the BAR packet and specifies the data size D_{B} of the BAR packet. Then, the packet length calculating unit 24 calculates the packet length T_{d} on the basis of, for example, Equation (2) described above (Step S306). Then, the packet length calculating unit 24 transmits the calculated packet length T_{d} to the response time calculating unit 25. Then, the AP 20 ends the packet length calculation process indicated by the flowchart.

Furthermore, if the VHT field is not present in the MAC header (No at Step S303), the packet length calculating unit 24 refers to the bit in the HT-SIG field and determines whether packet aggregation is available (Step S307). If the packet aggregation is available (Yes at Step S307), the packet length calculating unit 24 performs the process indicated by Step S304.

In contrast, if packet aggregation is unavailable (No Step S307), the packet length calculating unit 24 calculates the packet length T_{d} on the basis of, for example, Equation (1) described above (Step S308). Then, the packet length calculating unit 24 transmits the calculated packet length T_{d} to the response time calculating unit 25. Then, the AP 20 ends the packet length calculation process indicated by the flowchart. Furthermore, if neither the HT-SIG nor VHT-SIG fields are present in the wireless header (No at Step S302), the packet length calculating unit 24 performs the process indicated by Step S308.

A description will be continued by referring back to FIG. 11. The response time calculating unit 25 specifies, as the first response time, the time that is the amount of time from the start time specified at Step S200 to the time at which the terminal ID of the terminal device 13 that is the transmission source of the ACK packet is received from the receiving unit 29 at Step S102. Then, the response time calculating unit 25 calculates the second response time by subtracting the packet length T_{d} calculated at Step S300 from the specified first response time (Step S106).

Then, each of the measurement values is registered in the separate table 2301 in the measurement value table 230 associated with the terminal ID of the terminal device 13 selected at Step S100 (Step S107). Specifically, if the ACK packet is received from the terminal device 13, the response time calculating unit 25 registers the calculated second response time in the separate table 2301. Furthermore, if the ACK packet is received from the terminal device 13, the packet loss rate calculating unit 26 registers, in the separate table, 0 indicating that a packet loss did not occur. Furthermore, if the ACK packet is received from the terminal device 13, the RSSI registering unit 27 registers, in the separate table 2301, the value of the RSSI of the ACK packet.

In contrast, if the ACK packet is not received from the terminal device 13, the response time calculating unit 25 registers, as the second response time in the separate table 2301, the time that is the amount of time from the start time specified at Step S200 to the time point at which the packet loss is notified. Furthermore, the packet loss rate calculating unit 26 registers, in the separate table 2301, 1 indicating that a packet loss has occurred.

Then, the response time calculating unit 25 determines whether the data packets have been transmitted the predetermined number of times (Step S108). In the embodiment, the response time calculating unit 25 transmits the data packet to each of the terminal devices 13, for example, about several tens of times. If the data packet is not transmitted the predetermined number of times (No Step S108), the AP 20 again performs the process indicated by Step S200.

In contrast, if the data packets have been transmitted the predetermined number of times (Yes at Step S108), the response time calculating unit 25 determines whether all of the terminal devices 13 attributed to the AP 20 are selected (Step S109). If the terminal device 13 that is not selected is present (No at Step S109), the response time calculating unit 25 again performs the process indicated by Step S100.

In contrast, if all of the terminal devices 13 attributed to the AP 20 have been selected (Yes at Step S109), the response time calculating unit 25 refers to the separate table 2301 in the measurement value table 230 for each of the terminal devices 13. Then, the response time calculating unit 25 calculates the reference value of the response time by averaging the second response time for each of the terminal devices 13 (Step S110). Furthermore, the response time calculating unit 25 refers to the separate table 2301 in the measurement value table 230 for each of the terminal devices 13 and calculates the degree of variation in the second response time as a response time margin (Step S110). Then, the response time calculating unit 25 registers, in a response time table 241 for each of the terminal devices 13, the calculated reference value and the response time margin by associating the reference value and the response time margin with the terminal ID.

Then, the determination unit 22 performs an exclusion terminal specifying process (Step S111). At Step S111, the determination unit 22 refers to the separate table 2301 in the measurement value table 230 for each of the terminal devices 13 and specifies the terminal device 13 having the average RSSI equal to or less than a predetermined threshold as the terminal device 13 that has a high possibility of being affected by fading. Then, the determination unit 22 registers the terminal ID of the specified terminal device 13 in the list 1 in the terminal list table 235. Then, the AP 20 ends the reference value creating process indicated by the flowchart.

Measurement Process

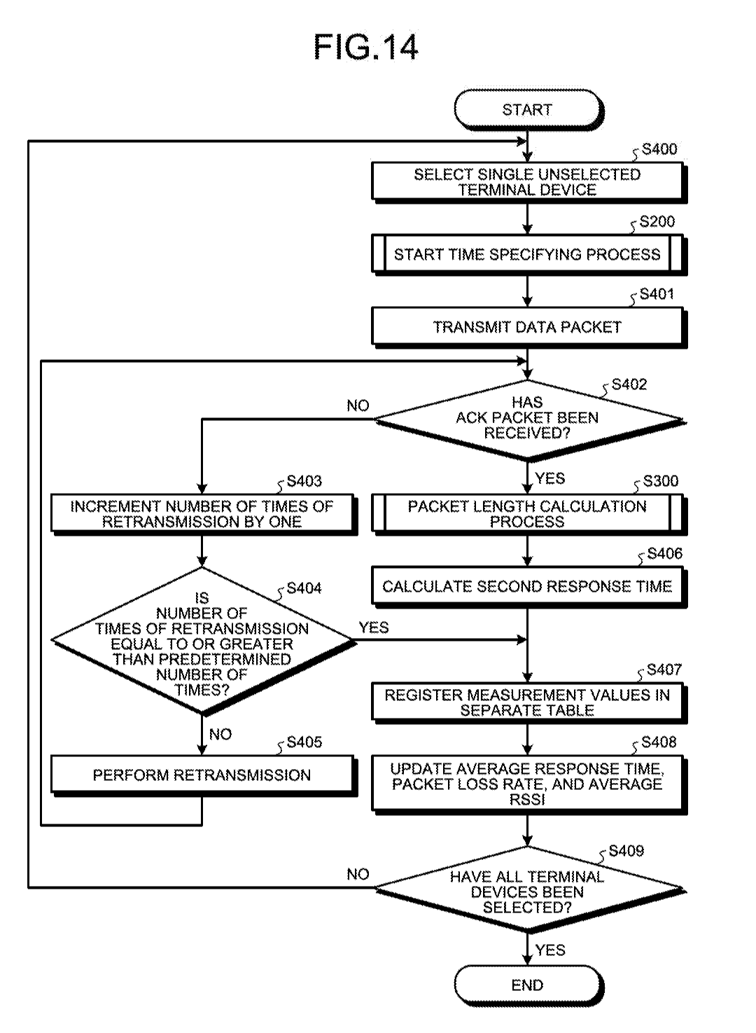

FIG. 14 is a flowchart illustrating an example of a measurement process. The AP 20 performs the measurement process indicated by the flowchart at, for example, a predetermined timing (for example, every few seconds).

First, the response time calculating unit 25 selects the single terminal device 13 that has not been selected from among the terminal devices 13 attributed to the AP 20 (Step S400). Then, the response time calculating unit 25 performs the start time specifying process, which has been described with reference to FIG. 12, on the selected terminal device 13 (Step S200).

Then, the transmission unit 28 transmits the data packet instructed from the communication control unit 21 or the response time calculating unit 25 (Step S401). Then, the receiving unit 29 determines whether the ACK packet is received within the predetermined time after the transmission of the data packet (Step S402).

If the receiving unit 29 does not receive the ACK packet within the predetermined time (No at Step S402), the transmission unit 28 increments the number of times of retransmission by one (Step S403). Then, the transmission unit 28 determines whether the number of times of retransmission is equal to or greater than the predetermined number of times (Step S404). If the number of times of retransmission is less than the predetermined number of times (No at Step S404), the transmission unit 28 retransmits the data packet (Step S405) and the receiving unit 29 again performs the process indicated by Step S402.

In contrast, if the number of times of retransmission is equal to or greater than the predetermined number of times (Yes at Step S404), the transmission unit 28 notifies the response time calculating unit 25 of the packet loss of the data packet together with the terminal ID of the terminal device 13 that is the destination of the data packet. Then, the process indicated by Step S407 is performed.

If the receiving unit 29 receives the ACK packet within the predetermined time (Yes at Step S402), the receiving unit 29 transmits, to the response time calculating unit 25, the packet loss rate calculating unit 26, and the transmission unit 28, the terminal ID of the terminal device 13 that has transmitted the ACK packet. Furthermore, the receiving unit 29 transmits, to the RSSI registering unit 27, the RSSI measured at the time of reception of the ACK packet together with the terminal ID of the terminal device 13 that is the transmission source of the received ACK packet. Then, the response time calculating unit 25 transmits, to the packet length calculating unit 24, a request to calculate the packet length including the terminal ID of the terminal device 13 selected at Step S400. Then, the AP 20 performs the packet length calculation process, which has been described with reference to FIG. 13, on the data packets transmitted at Step S401 (Step S300).

Then, the response time calculating unit 25 specifies, as the first response time, the time that is the amount of time from the start time specified at Step S200 to the time at which the terminal ID of the terminal device 13 that is the transmission source of the ACK packet is received from the receiving unit 29. Then, the response time calculating unit 25 calculates the second response time by subtracting the packet length T_{d} calculated at Step S300 from the specified first response time (Step S406).

Then, each of the measurement values is registered in the separate table 2301 in the measurement value table 230 associated with the terminal ID of the terminal device 13 selected at Step S400 (Step S407). Specifically, if the ACK packet from the terminal device 13 is received, the response time calculating unit 25 registers the calculated second response time in the separate table 2301. Furthermore, if the ACK packet from the terminal device 13 is received, the packet loss rate calculating unit 26 registers, in the separate table, 0 indicating that a packet loss did not occur. Furthermore, if the ACK packet from the terminal device 13 is received, the RSSI registering unit 27 registers the value of the RSSI of the ACK packet in the separate table 2301.

In contrast, if the ACK packet from the terminal device 13 is not received, the response time calculating unit 25 registers, in the separate table 2301 as the second response time, the time that is the amount of time from the start time specified at Step S200 to the time point at which the packet loss is notified. Furthermore, the packet loss rate calculating unit 26 registers, in the separate table 2301, 1 indicating that a packet loss has occurred.

Then, regarding the terminal device 13 selected at Step S400, the average response time, the packet loss rate, and the average RSSI are updated (Step S408). Specifically, regarding the terminal device 13 selected at Step S400, the response time calculating unit 25 refers to the separate table 2301 in the measurement value table 230 and calculates the average response time by averaging the predetermined number of response time in the order the pieces of the response time are newly registered. Then, the response time calculating unit 25 updates, in the response time table 231, the average response time associated with the terminal ID of the terminal device 13 selected at Step S400 to the calculated average response time.

Furthermore, regarding the terminal device 13 selected at Step S400, the packet loss rate calculating unit 26 refers to the separate table 2301 in the measurement value table 230 and calculates the packet loss rate by averaging the values of the predetermined number of packet losses in the order the packet losses are newly registered. Then, in the packet loss rate table 232, the packet loss rate calculating unit 26 updates the packet loss rate associated with the terminal ID of the terminal device 13 selected at Step S400 to the calculated packet loss rate.

Furthermore, regarding the terminal device 13 selected at Step S400, the RSSI registering unit 27 refers to the separate table 2301 in the measurement value table 230 and calculates the average RSSI by averaging the predetermined number of RSSIs in the order the RSSIs are newly registered. Then, in the RSSI table 233, the RSSI registering unit 27 updates the average RSSI associated with the terminal ID of the terminal device 13 selected at Step S400 to the calculated average RSSI.

Then, the response time calculating unit 25 determines whether all of the terminal devices 13 attributed to the AP 20 have been selected (Step S409). If the terminal device 13 that has not been selected is present (No at Step S409), the response time calculating unit 25 again performs the process indicated by Step S400. In contrast, if all of the terminal devices 13 have been selected (Yes at Step S409), the AP 20 ends the measurement process indicated by the flowchart.

Failure Determination Process

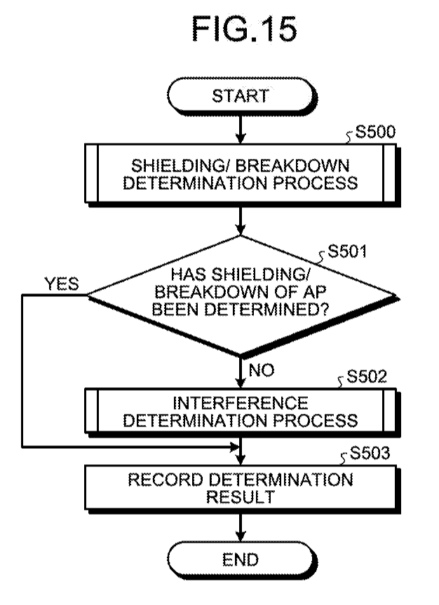

FIG. 15 is a flowchart illustrating an example of a failure determination process. The AP 20 performs the failure determination process indicated by the flowchart at, for example, a predetermined timing (for example, every 10 minutes) in the time zone in which, for example, each of the terminal devices 13 transmits and receives a data packet.

First, the AP 20 performs a shielding/breakdown determination process, which will be described later (Step S500). Then, the AP 20 determines whether shielding or a breakdown of the AP 20 has been determined (Step S501). If shielding or a breakdown of the AP 20 is determined (Yes at Step S501), the determination result indicating the shielding or the breakdown of the of the AP 20 is the cause of the failure is registered in the log table 234 in the holding unit 23 together with the time at which the determination has been performed (Step S503). Then, the AP 20 ends the failure determination process indicated by the flowchart.

In contrast, if shielding or a breakdown of the AP 20 is not determined (No at Step S501), the AP 20 performs an interference determination process that will be described later (Step S502). Then, the AP 20 registers the result determined by the interference determination process in the log table 234 in the holding unit 23 as the cause of the failure together with the time at which the determination has been performed (Step S503). Then, the AP 20 ends the failure determination process indicated by the flowchart.

Shielding/Breakdown Determination Process

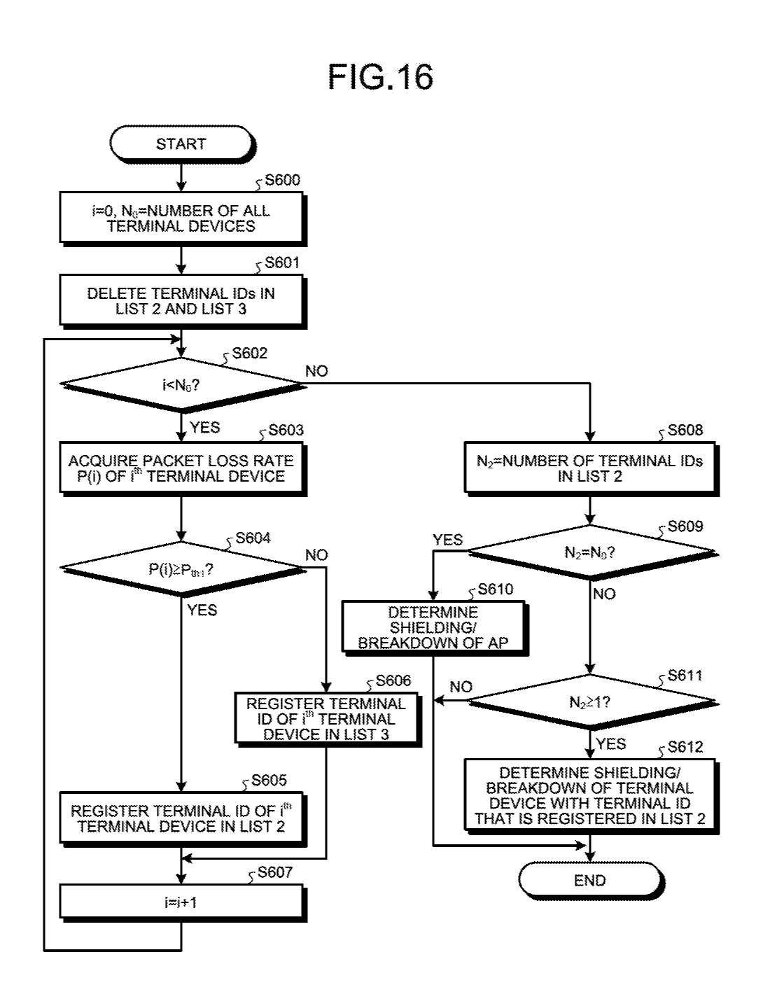

FIG. 16 is a flowchart illustrating an example of a shielding/breakdown determination process.

First, the determination unit 22 initializes the value of the variable i to 0 and sets the number of all of the terminal devices 13 attributed to the AP 20 to the constant N₀ (Step S600). Then, the determination unit 22 deletes all of the terminal IDs in a list 2 and a list 3 in the terminal list table 235 (Step S601). Then, the determination unit 22 determines whether the value of the variable i is less than the constant N₀ (Step S602).

If the value of the variable i is less than the constant N₀ (Yes at Step S602), the determination unit 22 refers to the packet loss rate table 232 in the holding unit 23 and acquires the packet loss rate P(i) of the i^{th} terminal device 13 from among the terminal devices 13 attributed to the AP 20 (Step S603). Then, the determination unit 22 determines whether the acquired packet loss rate P(i) is equal to or greater than a predetermined threshold Pₜₕ₁ (Step S604). In the embodiment, the threshold Pₜₕ₁ is, for example, 100%.

If the packet loss rate P(i) is equal to or greater than the threshold Pₜₕ₁ (Yes at Step S604), the determination unit 22 registers the terminal ID of the i^{th} terminal device 13 in the list 2 that is the list of the terminal devices 13 that are suspected of being broken down or shielded (Step S605). In contrast, if the packet loss rate P(i) is less than the threshold Pₜₕ₁ (No at Step S604), the determination unit 22 registers the terminal ID of the i^{th} terminal device 13 in the list 3 that is the list of the terminal devices 13 candidate for the determination target for interference (Step S606). Then, the determination unit 22 increments the value of the variable i by one (Step S607) and again performs the process indicated by Step S602.

If the value of the variable i is equal to or greater than the constant N₀ (No at Step S602), the determination unit 22 sets the number of terminal IDs in the in the list 2 to the constant N₂ (Step S608). Then, the determination unit 22 determines whether the value of the constant N₂ and the value of the constant N₀ that indicates the number of all of the terminal devices 13 attributed to the AP 20 are the same (Step S609). If the value of the constant N₂ and the value of the constant N₀ are the same (Yes at Step S609), i.e., if the packet loss rate P(i) of all of the terminal devices 13 attributed to the AP 20 is equal to or greater than the threshold Pₜₕ₁, the determination unit 22 determines that the state is a breakdown or shielding of the AP 20 (Step S610). Consequently, at Step S503 illustrated in FIG. 15, the determination result indicating that the breakdown or shielding of the AP 20 is the cause of the failure is registered in the log table 234 in the holding unit 23. Then, the determination unit 22 ends the shielding/breakdown determination process indicated by the flowchart.

In contrast, if the value of the constant N₂ and the value of the constant N₀ are different (No at Step S609), the determination unit 22 determines whether the value of the constant N₂ is equal to or greater than 1 (Step S611). If the value of the constant N₂ is zero (No at Step S611), i.e., if the terminal device 13 having the packet loss rate P(i) equal to or greater than the threshold Pₜₕ₁ is not present at all, the determination unit 22 ends the shielding/breakdown determination process indicated by the flowchart. In contrast, if the constant N₂ is equal to or greater than one (Yes at Step S611), i.e., if the packet loss rate P(i) of some of the terminal devices 13 is equal to or greater than the threshold Fₜₕ₁, the determination unit 22 determines that the state is the breakdown or shielding of the terminal device 13 with the terminal ID that is registered in the list 2 (Step S612). Consequently, at Step S503 illustrated in FIG. 15, the determination result indicating that the breakdown or shielding of the terminal device 13 is the cause of the failure is registered in the log table 234 in the holding unit 23 together with the terminal ID registered in the list 2.

Interference Determination Process

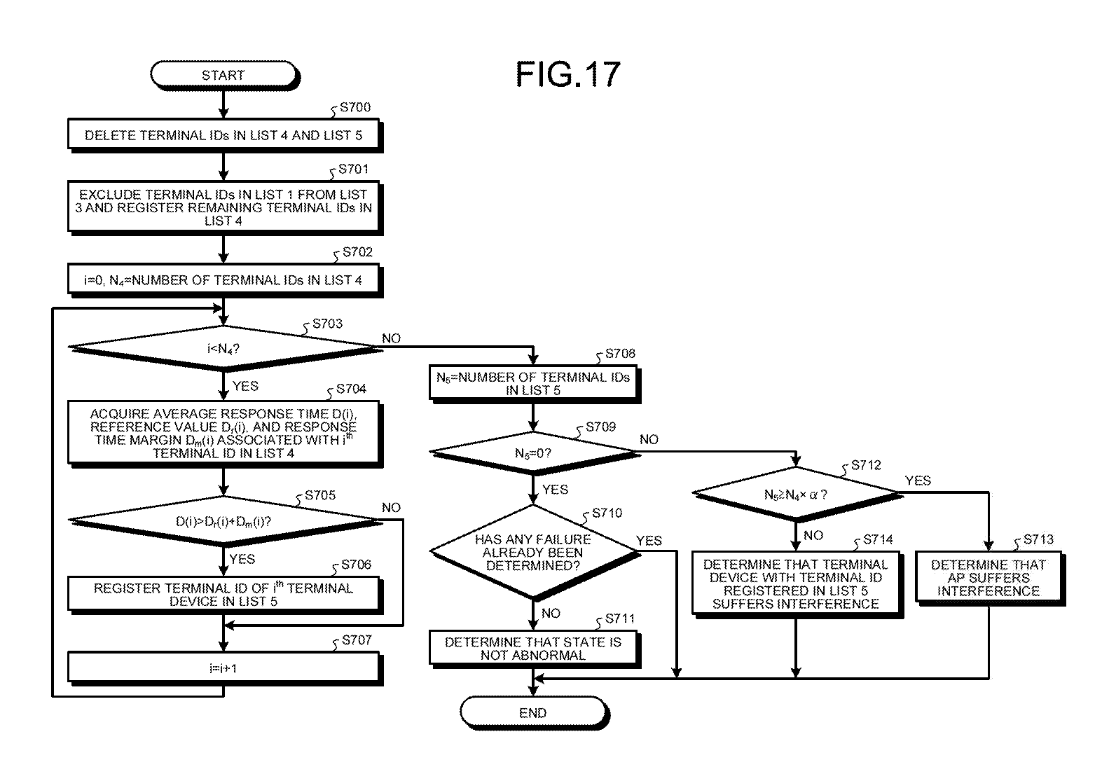

FIG. 17 is a flowchart illustrating an example of an interference determination process.

First, the determination unit 22 deletes all of the terminal IDs in the list 4 and a list 5 in the terminal list table 235 (Step S700). Then, the determination unit 22 excludes, from the list 3 in the terminal list table 235, the terminal IDs in the list 1 in the terminal list table 235. Then, the determination unit 22 registers, in the list 4, the terminal IDs remaining in the list 3 (Step S701). Then, the determination unit 22 initializes the value of the variable i to zero and sets the number of terminal IDs in the list 4 to the constant N₄ (Step S702).

Then, the determination unit 22 determines whether the value of the variable i is less than the constant N₄ (Step S703). If the value of the variable i is less than the constant N₄ (Yes at Step S703), the determination unit 22 refers to the response time table 231 and acquires the average response time D(i), the reference value Dᵣ(i), and the response time margin Dₘ(i) associated with the i^{th} terminal ID in the list 4 (Step S704). Then, the determination unit 22 determines whether the average response time D(i) is longer than the time that is the sum total of the reference value Dᵣ(i) and the response time margin Dₘ(i) (Step S705). Hereinafter, the time that is the sum total of the reference value Dᵣ(i) and the response time margin Dₘ(i) is sometimes referred to as a threshold for interference determination.

If the average response time D(i) is equal to or less than the time that is the sum total of the reference value Dᵣ(i) and the response time margin Dₘ(i) (No at Step S705), the determination unit 22 increments the value of the variable i by one (Step S707) and again performs the process indicated by Step S703. In contrast, if the average response time D(i) is greater than the time that is the sum total of the reference value Dᵣ(i) and the response time margin Dₘ(i) (Yes at Step S705), the determination unit 22 registers the i^{th} terminal ID in the list 5 (Step S706). The list 5 is the list of the terminal devices 13 that are suspected of interference. Then, the determination unit 22 performs the process indicated by Step S707.

If the value of the variable i is equal to or greater than the constant N₄ (No at Step S703), the determination unit 22 sets the number of terminal IDs in the list 5 to the constant N₅ (Step S708). Then, the determination unit 22 determines whether the constant N₅ is zero (Step S709). If the constant N₅ is zero (Yes at Step S709), i.e., if the terminal device 13 suspected of interference is not present, the determination unit 22 determines, in the shielding/breakdown determination process described above, whether any failure has already been determined (Step S710).

If determination of any failure has already been given (Yes at Step S710), the determination unit 22 ends the interference determination process indicated by the flowchart. In contrast, if determination of failure is not given (No at Step S710), the determination unit 22 determines that this state is not abnormal (Step S711). Consequently, at Step S503 illustrated in FIG. 15, the determination result indicating free of abnormality is registered in the log table 234 in the holding unit 23. Then, the AP 20 ends the interference determination process indicated by the flowchart.

In contrast, if the constant N₅ is not zero (No at Step S709), i.e., if the terminal device 13 that is suspected of interference is present, the determination unit 22 determines whether the constant N₅ is equal to or greater than the value obtained by multiplying a predetermined constant α by the constant N₄ (Step S712). The predetermined constant α is a value smaller than 1 and is, for example, 0.9. If the constant N₅ is equal to or greater than the value obtained by multiplying the predetermined constant α by the constant N₄ (Yes at Step S712), the determination unit 22 determines that the AP 20 is subjected to interference (Step S713). Consequently, at Step S503 illustrated in FIG. 15, the cause of the failure indicating that the AP 20 is subjected to interference is registered as the determination result in the log table 234 in the holding unit 23. Then, the AP 20 ends the interference determination process indicated by the flowchart.

In contrast, if the constant N₅ is less than the value obtained by multiplying the predetermined constant α by the constant N₄ (No at Step S712), the determination unit 22 determines that the terminal device 13 with the terminal ID registered in the list 5 is subjected to interference (Step S714). Consequently, at Step S503 illustrated in FIG. 15, the cause of the failure indicating that the terminal device 13 is subjected to interference is registered in the log table 234 in the holding unit 23 as the determination result together with the terminal ID that is registered in the list 5. Then, the AP 20 ends the interference determination process indicated by the flowchart.

Simulation Result

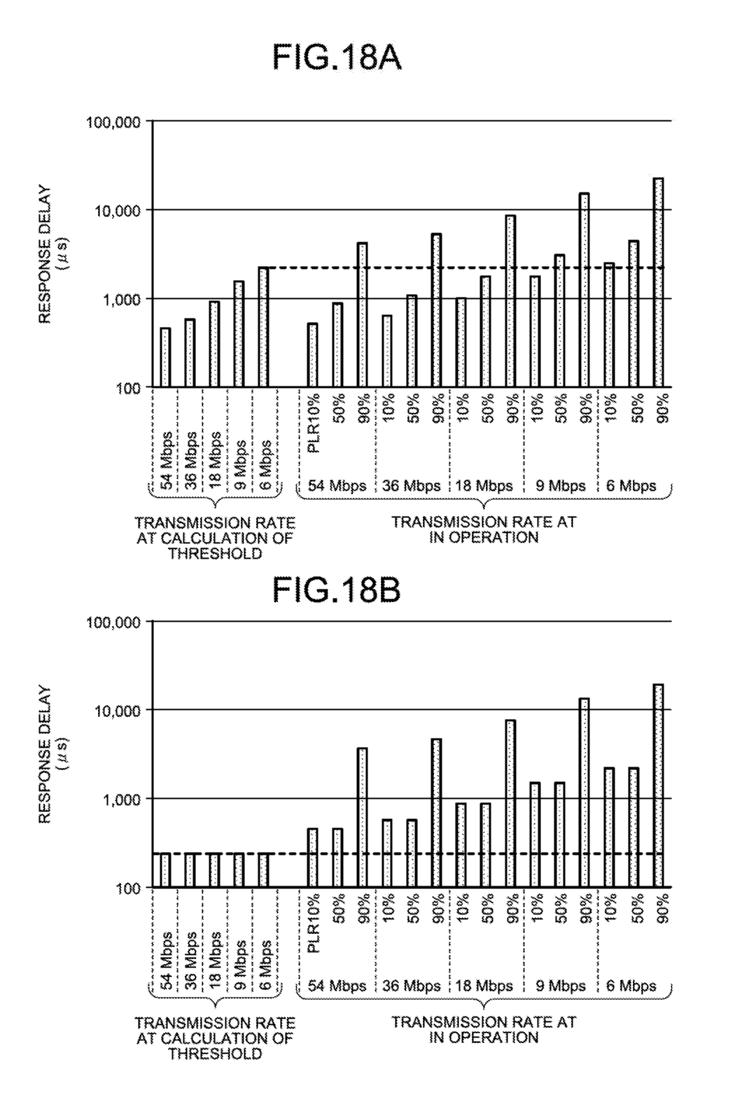

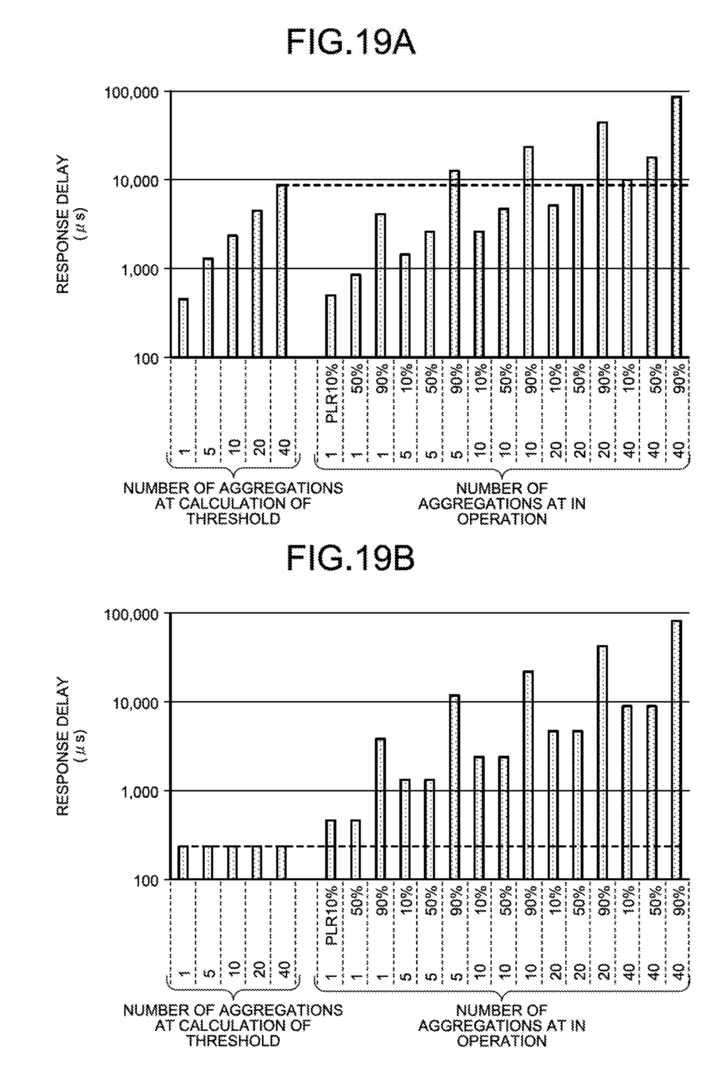

FIGS. 18A and 18B and FIGS. 19A and 19B are schematic diagrams each illustrating an example of simulation results. FIGS. 18A and 18B indicate the detection results of interference when the transmission rate of the data packet is changed due to a change in MCS or the like. FIGS. 19A and 19B indicate the detection results of interference when the number of data packets that are continuously transmitted or that are transmitted in a concatenated manner due to packet aggregation. In diagrams illustrated in FIGS. 18A and 19A, a threshold for interference detection is calculated on the basis of the first response time. In diagrams illustrated in FIGS. 18B and 19B, a threshold for interference determination is calculated on the basis of the second response time. In FIGS. 18A and 18B and FIGS. 19A and 19B, the first response time or the second response time of the data packet in operation exceeds the threshold indicated by the broken line, it is determined that interference is present.

If the transmission rate of the data packet is changed, the packet length T_{d} that is the temporal length of the data packet is changed and the first response time is also changed. If the transmission rate of the data packet becomes low, the packet length T_{d} of the data packet is increased and the first response time also becomes long. In the example illustrated in FIG. 18A, the first response time when the transmission rate of the data packet is low is calculated as the threshold for interference determination.

On the right side of FIG. 18A, the first response time obtained when the packet loss rate (PLR) due to interference is changed for each transmission rate of the data packet is illustrated. As indicated on the right side of FIG. 18A, if the packet loss rate is increased, the first response time of the data packet in operation tends to exceed the threshold. Consequently, as the packet loss rate is increased, the result of determination tends to indicate that interference is present. However, if the packet loss rate is decreased, the first response time of the data packet in operation does not tend to exceed the threshold. Consequently, as the packet loss rate is decreased, the result of determination tends to indicate that interference is not present. In the example illustrated in FIG. 18A, simulation is performed by setting the situation in which a packet loss occurs due to interference. However, in the simulation result illustrated in FIG. 18A, erroneous determination indicating that 21.3% is not subjected to interference is obtained.

On the right side of FIG. 18B, the second response time obtained when the packet loss rate due to interference is changed for each transmission rate of the data packet is illustrated. In the diagram illustrated in FIG. 18B, the threshold for interference determination is calculated on the basis of the second response time obtained by subtracting the packet length T_{d} from the first response time. Consequently, even if the transmission rate of the data packet is changed, the threshold for interference determination is not changed. As indicated on the right side of FIG. 18B, if the threshold for interference determination is calculated on the basis of the second response time, the second response time of the data packet exceeds the threshold in each of all of the combinations of the transmission rate and the packet loss rate. Consequently, if the threshold is calculated on the basis of the second response time, in all of the combinations of the transmission rate and the packet loss rate, it is determined that interference is present. Thus, in the simulation result illustrated in FIG. 18B, the rate of erroneous determination indicating that interference is not present is 0%.

In the example illustrated in FIG. 19A, the first response time of a case in which the number of data packets (hereinafter, referred to as the number of aggregations) that are continuously transmitted or that are transmitted in a concatenated manner due to packet aggregation is great is calculated as the threshold for interference determination. On the right side of FIG. 19A, the first response time of a case in which the packet loss rate due to interference is changed for each of the number of aggregations is indicated. As indicated on the right side of FIG. 19A, if the number of aggregations is increased, the first response time of the data packets tends to exceed the threshold for interference determination. Thus, as the number of aggregations is increased, the result of determination tends to indicate that interference is present, whereas, if the number of aggregations is decreased, the first response time of the data packets does not tend to exceed the threshold. Consequently, as the number of aggregations is decreased, the result of determination tends to indicate that interference is not present. In the example illustrated in FIG. 19A, simulation is performed by setting the situation in which a packet loss occurs due to interference. However, in the simulation result illustrated in FIG. 19A, erroneous determination indicating that 25.3% is not subjected to interference.

On the right side of FIG. 19B, the second response time when the packet loss rate due to interference is changed for each of the number of aggregations. In the diagram illustrated in FIG. 19B, because the threshold for interference determination is calculated on the basis of the second response time, even if the number of aggregations is changed, the threshold for interference determination is not changed. As indicated on the right side of FIG. 19B, if the threshold for interference determination is calculated on the basis of the second response time, the second response time of the data packets exceeds the threshold in all of the combinations of the number of aggregations and the packet loss rate. Consequently, if the threshold for interference determination is calculated on the basis of the second response time, it is determined that interference is present in all of the combinations of the number of aggregations and the packet loss rate. Thus, in the simulation result illustrated in FIG. 19B, the rate of erroneous determination indicating that interference is not present is 0%. In this way, by determining the presence or absence of interference on the basis of the second response time, it is possible to improve the accuracy of determination of the presence or absence of the interference.

### Effect of the Embodiment

As described above, the AP 20 according to the embodiment includes the transmission unit 28, the receiving unit 29, the packet length calculating unit 24, the response time calculating unit 25, and the determination unit 22. The transmission unit 28 transmits the data packet to the terminal device 13 in accordance with a transmission instruction. The receiving unit 29 receives, from the terminal device 13, an ACK packet with respect to the data packet transmitted to the terminal device 13. The packet length calculating unit 24 calculates the packet length that is the temporal length of the data packet transmitted to the terminal device 13. The response time calculating unit 25 calculates the second response time by subtracting the packet length calculated by the packet length calculating unit 24 from the first response time that is the amount of time from the transmission instruction described above to the reception of the ACK packet described above. The determination unit 22 determines, on the basis of the second response time, whether the terminal device 13 is subjected to interference. Consequently, the AP 20 can determine the occurrence of interference in a wireless network with high accuracy.

Furthermore, in the embodiment, the packet length calculating unit 24 calculates the packet length on the basis of the MCS used for the data packet. Consequently, the AP 20 can calculate the packet length of the data packet with high accuracy.

Furthermore, in the embodiment, when the terminal device 13 returns the ACK packet to the plurality of the data packets once, the packet length calculating unit 24 calculates, as the packet length, the time that is the sum total of each of the temporal lengths of a plurality of the data packets. Consequently, even if the block ACK is transmitted once with respect to the plurality of data packets that are concatenated due to packet aggregation, the AP 20 can subtract the temporal lengths of the concatenated data packets from the first response time. Consequently, the AP 20 can exclude an amount of variations of the number of concatenations of the data packets at the first response time. Thus, it is possible to determine the occurrence of interference in the wireless network with high accuracy regardless of the number of concatenations of the data packets.

Furthermore, in the embodiment, when the terminal device 13 returns an ACK packet with respect to a plurality of data packet once, the packet length calculating unit 24 calculates, as the packet length, the time by summing the time that is the sum of each of the temporal lengths of the plurality of the data packets and the time that is the sum of transmission waiting time between the adjacent data packets included in the plurality of the data packets. Consequently, even if a block ACK is sent to the plurality of the data packets that are continuously transmission once due to packet aggregation, the AP 20 can subtract the time taken to transmit the plurality of the data packets from the first response time. Consequently, the AP 20 can exclude, in the first response time, an amount of variation in the number of data packets that are continuously transmitted. Thus, determination of the occurrence of interference in a wireless network can be accurately performed regardless of the number of data packets that are continuously transmitted.

Furthermore, in the embodiment, when the terminal device 13 returns an ACK packet with respect to a plurality of the data packets once, the response time calculating unit 25 specifies, as the first response time, the time that is the amount of time from a transmission instruction with respect to the top data packet included in the plurality of the data packets to the reception of the ACK packet. Then, the response time calculating unit 25 calculates the time obtained by subtracting the packet length from the first response time as the second response time. Consequently, even if the data packets are continuously transmitted or are transmitted in a concatenated manner due to packet aggregation, the AP 20 can accurately measure the first response time.

Furthermore, in the AP 20 according to the embodiment, the packet length calculating unit 24 calculates the packet length by using at least one of the number of multiplexing used in MIMO and the number of multiplexing used in channel bonding. Consequently, the AP 20 can accurately calculate the packet length of a data packet.

Hardware

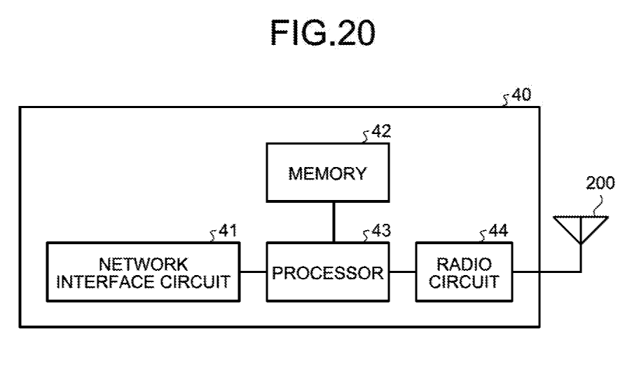

FIG. 20 is a block diagram illustrating an example of hardware of a communication device 40 that implements the AP 20. The communication device 40 includes, for example, as illustrated in FIG. 20, a network interface circuit 41, a memory 42, a processor 43, a radio circuit 44, and the antenna 200.

The network interface circuit 41 is an interface for connecting to the network device 12 by a wired connection. The network interface circuit 41 implements the function of, for example, the communication control unit 21. The radio circuit 44 performs a predetermined process, such as modulation or the like, on the signal output from the processor 43 and transmits the processed signal via the antenna 200. Furthermore, the radio circuit 44 performs a predetermined process, such as demodulation or the like, on the signal received via the antenna 200 and outputs the processed signal to the processor 43. The radio circuit 44 implements the function of, for example, the transmission unit 28 and the receiving unit 29.

The memory 42 stores therein programs for implementing the function of the communication control unit 21, the determination unit 22, the packet length calculating unit 24, the response time calculating unit 25, the packet loss rate calculating unit 26, the RSSI registering unit 27, the transmission unit 28, and the receiving unit 29. Furthermore, the memory 42 stores therein data of the measurement value table 230, the response time table 231, the packet loss rate table 232, the RSSI table 233, the log table 234, and the terminal list table 235 in the holding unit 23.

By reading the programs stored in the memory 42 from the memory 42 and executing the programs, the processor 43 implements the function of the determination unit 22, the packet length calculating unit 24, the response time calculating unit 25, the packet loss rate calculating unit 26, and the RSSI registering unit 27. Furthermore, by reading the programs stored in the memory 42 from the memory 42 and executing the programs, the processor 43 cooperates with the network interface circuit 41 and implements the function of the communication control unit 21. Furthermore, by reading the programs stored in the memory 42 from the memory 42 and executing the programs, the processor 43 cooperates with the radio circuit 44 and implements the function of the transmission unit 28 and the receiving unit 29.

Others

The technology disclosed in the present invention is not limited to the embodiments described above and various modifications are possible as long as they do not depart from the spirit of the present application.

For example, in the embodiments described above, the communication control unit 21, the determination unit 22, the holding unit 23, the packet length calculating unit 24, the response time calculating unit 25, the packet loss rate calculating unit 26, the RSSI registering unit 27, the transmission unit 28, and the receiving unit 29 are provided in the AP 20. However, the disclosed technology is not limited to this. For example, in a communication network in which the AP 20 is provided, a controller may also be provided and, in the controller, each of the functional blocks of the determination unit 22 and the holding unit 23 may also be provided. In this case, in the AP 20, each of the functional blocks of the communication control unit 21, the packet length calculating unit 24, the response time calculating unit 25, the packet loss rate calculating unit 26, the RSSI registering unit 27, the transmission unit 28, and the receiving unit 29 is provided. Then, by the controller and the AP 20 communicating with each other via a communication network, the controller and the AP 20 may cooperate with each other and implement the function of the AP 20 described above in the embodiment. Furthermore, the function of the AP 20 described above in the embodiment may also be arranged in three or more devices in a distributed manner and each of the devices communicate via a communication network with each other, whereby each of the devices may cooperate with each other and implement the function of AP 20 described above in the embodiment.

Furthermore, in the embodiment described above, the response time calculating unit 25 calculates the time obtained by subtracting the packet length from the first response time as the second response time; however, the disclosed technology is not limited to this. For example, the response time calculating unit 25 may also calculate the time obtained by subtracting both the packet length of a data packet and the packet length of an ACK packet from the first response time as the second response time. Consequently, because the data size of a normal ACK packet is different from that of a block ACK packet, it is possible to prevent variation in the second response time. Thus, the occurrence of interference can be accurately determined.

According to an aspect of an embodiment, the occurrence of interference in a wireless network can be accurately determined.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A wireless communication device that is used in a wireless communication system that includes the wireless communication device and a plurality of terminal devices, the wireless communication device comprising:
a transmission unit that transmits a data packet to the terminal device in accordance with a transmission instruction;
a receiving unit that receives, from the terminal device, a response with respect to the data packet transmitted to the terminal device;
a first calculating unit that calculates a packet length that is a temporal length of the data packet transmitted to the terminal device;
a second calculating unit that calculates second response time by subtracting the packet length from first response time that is amount of time from the transmission instruction to reception of the response; and
a determination unit that determines, based on the second response time, whether the terminal device is subjected to interference.

2. The wireless communication device according to claim 1, wherein the first calculating unit calculates the packet length on the basis of the modulation and coding scheme (MCS) used for the data packet.

3. The wireless communication device according to claim 1, wherein, when the terminal device returns the response with respect to a plurality of the data packets once, the first calculating unit calculates, as the packet length, time that is sum of each of the temporal lengths of the plurality of the data packets.

4. The wireless communication device according to claim 1, wherein, when terminal device returns the response with respect to a plurality of the data packets once, the first calculating unit calculates, as the packet length, time by summing time that is sum of each of the temporal lengths of the plurality of the data packets and time that is sum of transmission waiting time between the adjacent data packets included in the plurality of the data packets.

5. The wireless communication device according to claim 3, wherein the second calculating unit specifies, as the first response time, the time that is amount of time from the transmission instruction with respect to a top data packet among the plurality of the data packets to reception of the response with respect to the plurality of the data packets and calculates, as the second response time, the time by subtracting the packet length from the first response time.

6. The wireless communication device according to claim 4, wherein the second calculating unit specifies, as the first response time, the time that is amount of time from the transmission instruction with respect to a top data packet among the plurality of the data packets to reception of the response with respect to the plurality of the data packets and calculates, as the second response time, the time by subtracting the packet length from the first response time.

7. The wireless communication device according to claim 1, wherein the first calculating unit calculates the packet length by using at least one of number of multiplexing used in Multi-Input Multi-Output (MIMO) and number of multiplexing used in channel bonding.

8. A wireless communication system comprising:
a wireless communication device; and
a plurality of terminal devices, wherein
the wireless communication device includes
a transmission unit that transmits a data packet to the terminal device in accordance with a transmission instruction,
a receiving unit that receives, from the terminal device, a response with respect to the data packet transmitted to the terminal device,
a first calculating unit that calculates a packet length that is a temporal length of the data packet transmitted to the terminal device,
a second calculating unit that calculates second response time by subtracting the packet length from first response time that is amount of time from the transmission instruction to reception of the response, and
a determination unit that determines, based on the second response time, whether the terminal device is subjected to interference.

9. An interference determination method used in a wireless communication system that includes a wireless communication device and a plurality of terminal devices, the interference determination method comprising:
transmitting, performed by the wireless communication device, a data packet to the terminal device in accordance with a transmission instruction;
receiving, from the terminal device performed by the wireless communication device, a response with respect to the data packet transmitted to the terminal device;
calculating, performed by the wireless communication device, a packet length that is a temporal length of the data packet transmitted to the terminal device;
calculating, performed by the wireless communication device, second response time by subtracting the packet length from first response time that is amount of time from the transmission instruction to reception of the response; and
determining, performed by the wireless communication device, based on the second response time, whether the terminal device is subjected to interference.
